(19) United States
(12) Patent Application Publication
(10) Pub. No.: US 2024/0403600 A1
(43) Pub. Date: Dec. 5, 2024

(54) PROCESSING-IN-MEMORY BASED ACCELERATING DEVICES, ACCELERATING SYSTEMS, AND ACCELERATING CARDS

(71) Applicant: SK hynix Inc., Icheon-si Gyeonggi-do (KR)

(72) Inventors: Yong Kee KWON, Icheon-si Gyeonggi-do (KR); Gu Hyun KIM, Icheon-si Gyeonggi-do (KR); Nah Sung KIM, Icheon-si Gyeonggi-do (KR); Chang Hyun KIM, Icheon-si Gyeonggi-do (KR); Gyeong Cheol SHIN, Icheon-si Gyeonggi-do (KR); Byeong Ju AN, Icheon-si Gyeonggi-do (KR); Hae Rang CHOI, Icheon-si Gyeonggi-do (KR)

(73) Assignee: SK hynix Inc., Icheon-si Gyeonggi-do (KR)

(21) Appl. No.: 18/507,591

(22) Filed: Nov. 13, 2023

(30) Foreign Application Priority Data
Jun. 2, 2023 (KR) 10-2023-0071543

(51) Int. Cl. G06N 3/042

(52) U.S. Cl. CPC G06N 3/042

(57) ABSTRACT

A processing-in-memory (PIM)-based accelerating device includes a plurality of PIM devices, a PIM network system configured to control traffic of signals and data for the plurality of PIM devices, and a first interface configured to perform interfacing with a host device. The PIM network system controls the traffic so that the plurality of PIM devices perform different operations, the plurality of PIM devices perform different operations in groups, or the plurality of PIM devices perform the same operation in parallel.

### CROSS-REFERENCE TO RELATED APPLICATIONS

The present application claims priority under 35 U.S.C. 119 (a) to Korean Application No. 10-2023-0071543, filed on Jun. 2, 2023, in the Korean Intellectual Property Office, which is incorporated herein by reference in its entirety.

### BACKGROUND

### 1. Technical Field

Various embodiments of the present disclosure generally relate to processing-in-memory (hereinafter, referred to as “PIM”)-based accelerating devices, accelerating systems, and accelerating cards.

### 2. Related Art

Recently, neural network algorithms have shown dramatic performance improvements in various fields such as image recognition, voice recognition, and natural language processing. In the future, the neural network algorithms are expected to be actively used in various fields such as factory automation, medical services, and self-driving cars, and various hardware structures are being actively developed to efficiently process them. The neural network algorithm is a learning algorithm modeled after a neural network in biology. Recently, among multi-layer perceptron (hereinafter, referred to “MLP”) composed of two or more layers, a deep neural network (hereinafter, referred to “DNN”) composed of many layers of 8 or more have been actively studied. Currently, most neural network operations are performed using a graphics processing unit (hereinafter, referred to “GPU”). The GPU has a large number of cores, and thus is known to be efficient in performing simply repetitive operations and operations with high parallelism. However, in the case of DNN, which has been studied a lot recently, the DNN is composed of, for example, one million or more neurons, so the amount of operation is enormous. Accordingly, it is required to develop a hardware accelerator optimized for neural network operation having such a huge amount of operation.

### SUMMARY

A processing-in-memory (PIM)-based accelerating device according to an embodiment of the present disclosure may include a plurality of PIM devices, a PIM network system configured to control traffic of signals and data for the plurality of PIM devices, and a first interface configured to perform interfacing with a host device. The PIM network system may control the traffic so that the plurality of PIM devices perform different operations, the plurality of PIM devices perform different operations for each group, or the plurality of PIM devices perform the same operation in parallel.

A processing-in-memory (PIM)-based accelerating device according to an embodiment of the present disclosure may include a plurality of PIM devices, a PIM network system configured to control traffic of signal and data for the plurality of PIM devices, and a first interface configured to perform interfacing with a host device. Each of the plurality of PIM devices may include a PIM device constituting a first channel and a PIM device constituting a second channel. The PIM network system may control the traffic such that the plurality of PIM devices perform different operations, the plurality of PIM devices perform different operations in groups, or the plurality of PIM devices perform the same operation in parallel.

A processing-in-memory (PIM)-based accelerating device according to an embodiment of the present disclosure may include a plurality of PIM devices of a first group, a plurality of PIM devices of a second group, a first PIM network system configured to control traffic of signal and data of the plurality of PIM devices of the first group, a second PIM network system configured to control traffic of signal and data of the plurality of PIM devices of the second group, and a first interface configured to perform interfacing with a host device. The first PIM network system may control the traffic such that the plurality of PIM devices of the first group perform different operations, the plurality of PIM devices of the first group perform different operations in groups, or the plurality of PIM devices of the first group perform the same operation in parallel. The second PIM network system may control the traffic such that the plurality of PIM devices of the second group perform different operations, the plurality of PIM devices of the second group perform different operations in groups, or the plurality of PIM devices of the second group perform the same operation in parallel.

A processing-in-memory (PIM)-based accelerating system according to an embodiment of the present disclosure may include a plurality of PIM-based accelerating devices, and a host device coupled to the plurality of PIM-based accelerating devices through a system bus. Each of the plurality of PIM-based accelerating devices may include a first interface coupled to the system bus, and a second interface coupled to another PIM-based accelerating device.

A processing-in-memory (PIM)-based accelerating card according to an embodiment of the present disclosure may include a printed circuit board, a plurality of PIM devices mounted over the printed circuit board in forms of chips or packages, a PIM network system mounted over the printed circuit board in a form of a chip or a package and configured to control signal and data traffic of the plurality of PIM devices, a first interface device attached to the printed circuit board, and a second interface device attached to the printed circuit board.

A processing-in-memory (PIM)-based accelerating card according to an embodiment of the present disclosure may include a printed circuit board, a plurality of groups of a plurality of PIM devices mounted over the printed circuit board in forms of chips or packages, a plurality of PIM network systems mounted over the printed circuit board in forms of chips or packages and configured to control signal and data traffic of the plurality of groups, a first interface device attached to the printed circuit board, and a second interface device attached to the printed circuit board.

### BRIEF DESCRIPTION OF THE DRAWINGS

FIG. 1 is a block diagram illustrating a PIM-based accelerating device according to an embodiment of the present disclosure.

FIG. 2 is a layout diagram illustrating a first PIM device included in the PIM-based accelerating device of FIG. 1.

FIG. 3 is a block diagram illustrating the first PIM device included in the PIM-based accelerating device of FIG. 1.

FIG. 4 is a diagram illustrating an example of a neural network operation operation performed by first to eighth PIM devices of the PIM-based accelerating device of FIG. 1.

FIG. 5 is a diagram illustrating an example of a matrix multiplication operation used in an MLP operation of FIG. 4.

FIG. 6 is a circuit diagram illustrating an example of a first processing unit included in the first PIM device of FIG. 3.

FIG. 7 is a block diagram illustrating an example of a PIM network system included in the PIM-based accelerating device of FIG. 1.

FIG. 8 is a block diagram illustrating an example of a PIM interface circuit included in the PIM network system of FIG. 7.

FIG. 9 is a diagram illustrating an operation in a unicast mode of a multimode interconnect circuit included in the PIM network system of FIG. 7.

FIG. 10 is a diagram illustrating an operation in a multicast mode of the multimode interconnect circuit included in the PIM network system of FIG. 7.

FIG. 11 is a diagram illustrating an operation in a broadcast mode of the multimode interconnect circuit included in the PIM network system of FIG. 7.

FIG. 12 is a block diagram illustrating an example of a first PIM controller included in the PIM network system of FIG. 7.

FIG. 13 is a block diagram illustrating another example of the PIM network system included in the PIM-based accelerating device of FIG. 1.

FIG. 14 is a block diagram illustrating an example of a PIM interface circuit included in the PIM network system of FIG. 13.

FIG. 15 is a diagram illustrating an example of a host instruction transmitted from a host device to a PIM-based accelerating device according to the present disclosure.

FIG. 16 is a diagram illustrating a PIM-based accelerating device according to another embodiment of the present disclosure.

FIG. 17 is a block diagram illustrating an example of a configuration of a PIM network system included in the PIM-based accelerating device of FIG. 16, and a coupling structure between PIM controllers and first to eighth PIM devices in the PIM network system.

FIG. 18 is a block diagram illustrating another example of the configuration of the PIM network system included in the PIM-based accelerating device of FIG. 16, and a coupling structure between the PIM controllers and the first to eighth PIM devices in the PIM network system.

FIG. 19 is a block diagram illustrating a PIM-based accelerating device according to another embodiment of the present disclosure.

FIG. 20 is a block diagram illustrating a PIM-based accelerating device according to another embodiment of the present disclosure.

FIG. 21 is a block diagram illustrating a PIM-based accelerating device according to another embodiment of the present disclosure.

FIG. 22 is a block diagram illustrating a PIM-based accelerating system according to an embodiment of the present disclosure.

FIG. 23 is a block diagram illustrating a PIM-based accelerating system according to another embodiment of the present disclosure.

FIG. 24 is a diagram illustrating a PIM-based accelerating card according to an embodiment of the present disclosure.

FIG. 25 is a diagram illustrating a PIM-based accelerating card according to another embodiment of the present disclosure.

FIG. 26 is a diagram illustrating a PIM-based accelerating card according to another embodiment of the present disclosure.

FIG. 27 is a diagram illustrating a PIM-based accelerating card according to another embodiment of the present disclosure.

### DETAILED DESCRIPTION

In the following description of embodiments, it will be understood that although the terms “first,” “second,” “third,” etc. are used herein to describe various elements, these elements should not be limited by these terms. It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. The term “preset” means that the value of a parameter is predetermined when using that parameter in a process or algorithm. The value of the parameter may be set when a process or algorithm starts or may be set during a period during which a process or algorithm is performed, depending on embodiments.

A logic “high” level and a logic “low” level may be used to describe logic levels of signals. A signal having a logic “high” level may be distinguished from a signal having a logic “low” level. For example, when a signal having a first voltage correspond to a signal having a logic “high” level, a signal having a second voltage correspond to a signal having a logic “low” level. In an embodiment, the logic “high” level may be set as a voltage level which is higher than a voltage level of the logic “low” level. Meanwhile, the logic levels of signals may be set to be different or opposite according to the embodiments. For example, a certain signal having a logic “high” level in one embodiment may be set to have a logic “low” level in another embodiment, and a certain signal having a logic “low” level in one embodiment may be set to have a logic “high” level in another embodiment.

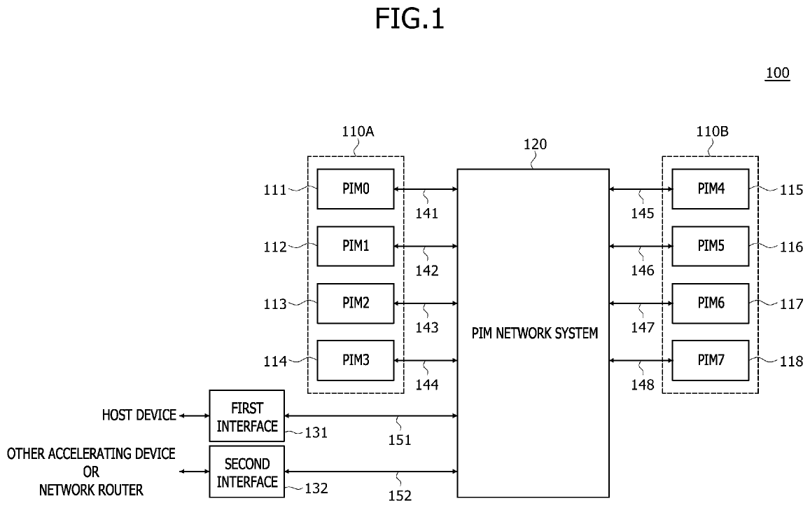

FIG. 1 is a block diagram illustrating a PIM-based accelerating device 100 according to an embodiment of the present disclosure. Referring to FIG. 1, the PIM-based accelerating device 100 may include a plurality of processing-in-memory (hereinafter, referred to as “PIM”) devices PIMs, for example, first to eighth PIM devices (PIM0-PIM7) 111-118, a PIM network system 120 for controlling the first to eighth PIM devices 111-118, a first interface 131, and a second interface 132.

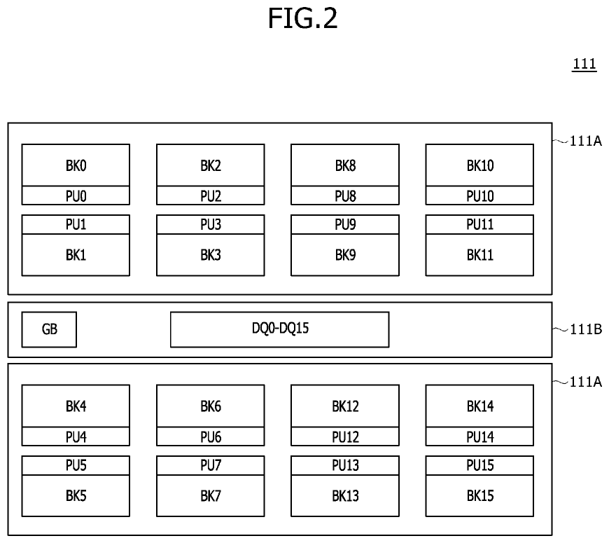

Each of the first to eighth PIM devices 111-118 may include at least one memory circuit and a processing circuit. In an example, the processing circuit may include a plurality of processing units. In an example, the first to eighth PIM devices 111-118 may be divided into a first PIM group 110A and a second PIM group 110B. The number of PIM devices included in the first PIM group 110A and the number of PIM devices included in the second PIM group 110B may be the same as each other. However, in another embodiment, the number of PIM devices included in the first PIM group 110A and the number of PIM devices included in the second PIM group 110B may be different from each other. As illustrated in FIG. 1, the first PIM group 110A may include the first to fourth PIM devices 111-114. The second PIM group 110B may include the fifth to eighth PIM devices 115-118. The first to eighth PIM devices 111-118 will be described in more detail below with reference to FIGS. 2 to 6.

The PIM network system 120 may control the first to eighth PIM devices 111-118. Specifically, the PIM network system 120 may control or adjust both signals and data, sent to and received from each of the first to eighth PIM devices 111-118. The PIM network system 120 may assign or direct each of the first to eighth PIM devices 111-118 to perform the same operation. The PIM network system 120 may assign or direct a subset of the eight PIM devices 111-118 to perform a particular operation and assign or direct each of the other PIM devices, i.e., PIM devices not part of the subset, to perform one or more other operations, which are different from the operation assigned to first subset of PIM devices. The PIM network system 120 may assign a different operation to each of the first to eighth PIM devices 111-118 to perform different operations. The PIM network system 120 may direct the first to eighth PIM devices 111-118 to perform different operations in groups, or direct the first to eighth PIM devices 111-118 to perform the same operation in parallel, i.e., at the same time, or sequentially with.

The PIM network system 120 may be coupled to the first to eighth PIM devices 111-118 through first to eighth signal/data lines 141-148, respectively. For example, the PIM network system 120 may transmit signals to the first PIM device 111 or exchange data with, i.e., send data to as well as receive data from, the first PIM device 111 through the first signal/data line 141. The PIM network system 120 may transmit signals to the second PIM device 112 or exchange data with, i.e., send data to as well as receive data from, the second PIM device 112 through the second signal/data line 142. In the same manner, the PIM network system 120 may transmit signals to the third to eighth PIM devices 113-118 or exchange data with i.e., send data to as well as receive data from, the third to eighth PIM devices 113-118 through the third to eighth signal/data lines 143-148, respectively.

The PIM network system 120 may be coupled to the first interface 131 through a first interface bus 151. In addition, the PIM network system 120 may be simultaneously coupled to the second interface 132 through a second interface bus 152.

As used herein, “interface” should be construed as a hardware or software component that connects two or more other components for the purpose of passing information from one to the other. “Interface” may also be construed as an act or method of connecting two or more components for the purpose of passing information from one to the other. A “bus” is a set (2 or more) electrically-parallel conductors, which form a signal transmission path. With regard to the words “signals” and “data,” both words refer to information. In that regard, a “signal,” which may be a command or an instruction to a processor for example, is nevertheless information. As used herein therefore and depending on the context of its use, the word “information” may refer to a signal, data or both signals and data.

In FIG. 1, the first interface 131 may perform interfacing between the PIM-based accelerating device 100 and a host device. The host device may include a central processing unit (CPU), but is not limited thereto. For example, the host device may include a master device having the PIM-based accelerating device 100 as a slave device. The first interface 131 may operate by a high-speed interface protocol. In an example, the first interface 131 may operate by a peripheral component interconnect express (PCIe) protocol, a compute express link (CXL) protocol, or a universal serial bus (USB) protocol. The first interface 131 may transmit signals and data transmitted from the host device to the PIM network system 120 through the first interface bus 151. The first interface 131 may transmit the signals and data transmitted from the PIM network system 120 through the first interface bus 151 to the host device.

The second interface 132 may perform interfacing between the PIM-based accelerating device 100 and another PIM-based accelerating device or a network router. In an example, the second interface 132 may be a device employing a communication standard, for example, an Ethernet standard. In an example, the second interface 132 may be a small, hot-pluggable transceiver for data communication, such as a small form-factor pluggable (SFP) port. In an example, the second interface 132 may be a Quad SFP (QSFP) port in which four SFP ports are combined into one. In this case, the QSFP port may be used as four SFP ports using a breakout cable, or may be bonded to be used at four times the speed of the SFP standard. The second interface 132 may transmit data transmitted from the PIM network system 120 of the PIM-based accelerating device 100 through the second interface bus 152 to a PIM network system of another PIM-based accelerating device directly or through a network router. In addition, the second interface 132 may transmit data transmitted from another PIM-based accelerating device directly or through the network router to the PIM network system 120 through the second interface bus 152.

As used herein, the term “memory bank” refers to a plurality of memory “locations” in one or more semiconductor memory devices, e.g., static or dynamic RAM. Each location may contain (store) digital data transmitted, i.e., copied or stored, into the location and which can be retrieved, i.e., read therefrom. A “memory bank” may have virtually any number of storage locations, each location being capable of storing different numbers of binary digits (bits).

FIG. 2 is a layout diagram illustrating a first PIM device 111 included in the PIM-based accelerating device 100 of FIG. 1. The description of the first PIM device 111 below may therefore apply to the second to eighth PIM devices (112 to 118 in FIG. 1) included in the PIM-based accelerating device 100.

Referring to FIG. 2, the first PIM device 111 may include storage/processing regions 111A and a peripheral circuit region 111B that are physically separated from each other. One or more processing units PU may be located in each of the storage/processing regions 111A, which may include a plurality of memory banks BKs, for example, first to sixteenth memory banks BK0-BK15. Each memory bank BK, may be associated with a corresponding processing unit PU, such that in FIG. 1, there are sixteen processing units PU0-PU15.
In the peripheral circuit region 111B, a second memory circuit and a plurality of data input/output circuits DQs, for example, first to sixteenth data input/output circuits DQ0-DQ15 may be disposed. In an example, the second memory circuit may include a global buffer GB.

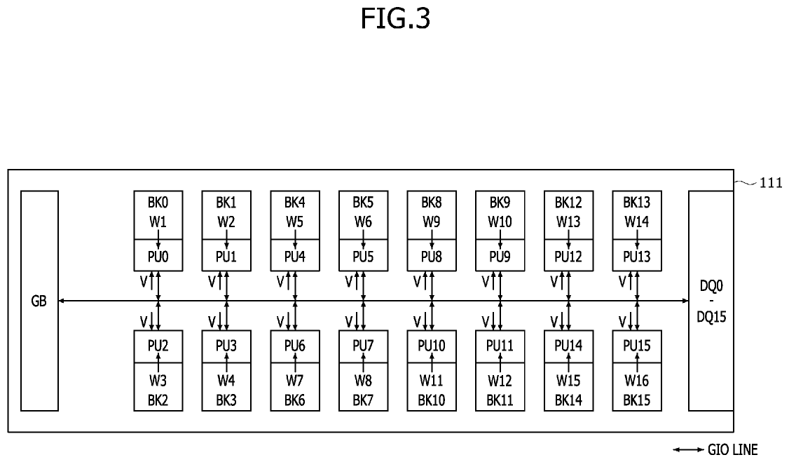

Each of the first to sixteenth processing units PU0-PU15 may be allocated to and operationally associated with one of the first to sixteenth memory banks BK0-BK15, respectively. Each processing unit may also be contiguous with its corresponding memory bank. For example, the first processing unit PU0 may be allocated and disposed adjacent to or at least proximate or near the first memory bank BK0. The second processing unit PU1 may be allocated and disposed in the second memory bank BK1. Similarly, the sixteenth processing unit PU15 may be allocated and disposed in the sixteenth memory bank BK15. As shown in FIG. 2 but seen best in FIG. 3, the first to sixteenth processing units PU0-PU15 may be commonly connected or coupled to the global buffer GB.

Each of the first to sixteenth memory banks BK0-BK15 may provide a quantity of data to a corresponding one of the first to sixteenth processing units PU0-PU15. In an example, a “first” data may be first to sixteenth weight data. In another example, the first to sixteenth memory banks BK0-BK15 may provide a plurality of pieces of “second” data together with the plurality of pieces of “first” data to one or more of the first to sixteenth processing units PU0-PU15. By way of example, the first data and the second data may be, for example, data used for element-wise multiplication (EWM) operation.

More specifically, one of the first to sixteenth processing units PU0-PU15 may receive one piece of weight data among the first to sixteenth weight data from the memory bank BK to which the processing unit PU is allocated. For example, the first processing unit PU0 may receive the first weight data from the first memory bank BK0. The second processing unit PU1 may receive the second weight data from the second memory bank BK1. In the same manner, the third to sixteenth processing units PU2-PU15 may receive the third to sixteenth weight data from the third to sixteenth memory banks BK2-BK15, respectively.

The global buffer GB may provide the second data to each of the first to sixteenth processing units PU0-PU15. In an example, the second data may be vector data or input activation data, which may be input to each layer of a fully-connected (FC) layer in a neural network operation such as MLP.

Referring again to FIG. 2, the first to sixteenth data input circuits DQ0-DQ15 may provide data transmission paths between the first PIM device 111 and the PIM network system (120 of FIG. 1). In an example, the first to sixteenth data input circuits DQ0-DQ15 may transmit data transmitted from the PIM network system (120 of FIG. 1), for example, the weight data and vector data to the first to sixteenth memory banks BK0-BK15 and the global buffer GB of the first PIM device 111, respectively. The first to sixteenth data input circuits DQ0-DQ15 may transmit the data transmitted from the first to sixteenth processing units PU0-PU15, for example, operation result data to the PIM network system (120 of FIG. 1). Although not shown in FIG. 2, the first to sixteenth data input circuits DQ0-DQ15 may exchange data with the first to sixteenth memory banks BK0-BK15 and the first to sixteenth processing units PU0-PU15 through a global input/output (GIO) line.

When a PIM device 111 does not have the same number of memory banks BK0-BK15 and processing units PU0-PU15, the number of memory banks and the number of processing units PU may be different from each other. In such an embodiment, a first PIM device 111 may have a structure in which two memory banks share one processing unit PU. In another embodiment, the number of processing units PU may be half the number of memory banks. In yet another embodiment, a single or “first” PIM device 111 may have a structure in which four memory banks share one processing unit PU. In such a case, the number of processing units PU may be ¼ of the number of memory banks.

FIG. 3 is a block diagram illustrating a PIM device 111 included in the PIM-based accelerating device 100 of FIG. 1. The description of the PIM device 111 below may therefore apply to the second to eighth PIM devices (112-118 in FIG. 1).

Referring to FIG. 3, the first PIM device 111 may include the first to sixteenth memory banks BK0-BK15, first to sixteenth processing units PU0-PU15, each of which may be associated with a single, corresponding memory bank BK. The PIM device 111 may also include a global buffer GB, the first to sixteenth data input/output circuits DQ0-DQ15, and a GIO line, to which the global buffer GB, the processing units, PU and the data input/output circuits DQ0-DQ15 are connected.

As described above with reference to FIG. 2, the first to sixteenth processing units PU0-PU15 may receive first to sixteenth weight data W1-W16 from the first to sixteenth memory banks BK0-BK15, respectively. Although not shown in FIG. 3, transmission of the first to sixteenth weight data W1-W16 may be performed through the GIO line or may be performed through a separate data line/bus between the memory bank BK and the processing unit PU. The first to sixteenth processing units PU0-PU15 may commonly receive vector data V through the global buffer GB. The first processing unit PU0 may perform operation using the first weight data W1 and the vector data V to generate first operation result data. The second processing unit PU1 may perform operation using the second weight data W2 and the vector data V to generate second operation result data. In the same manner, the third to sixteenth processing units PU2-PU15 may generate third to sixteenth operation result data, respectively. The first to sixteenth processing units PU0-PU15 may transmit the first to sixteenth operation result data to the first to sixteenth data input/output circuits DQ0-DQ15, respectively, through the GIO line.

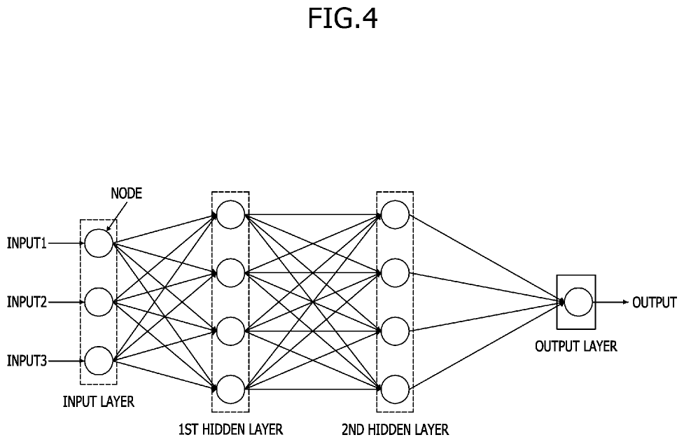

FIG. 4 is a diagram illustrating an example of a neural network operation performed by the first to eighth PIM devices 111-118 of the PIM-based accelerating device 100 of FIG. 1.

Referring to FIG. 4, a neural network may be composed of an MLP, including an input layer, at least one hidden layer, and an output layer. That the neural network includes two hidden layers is an example, but three or more hidden layers may be disposed between the input layer and the output layer. In the following examples, it is assumed that training for the MLP has already been performed and a weight matrix in each layer has been set. Each of the input layer, a first hidden layer, a second hidden layer, and the output layer may include at least one node.

As illustrated in FIG. 4, which depicts an example, the input layer may include three input terminals or nodes, the first hidden layer and the second hidden layer, both of which may each include four nodes. The output layer may include one node. The nodes of the input layer may receive input data INPUT1, INPUT2, and INPUT3. Output data output from the input layer may be used as input data of the first hidden layer. Output data output from the first hidden layer may be used as input data of the second hidden layer. In addition, output data output from the second hidden layer may be used as input data of the output layer.

The input data input to the input layer, the first hidden layer, the second hidden layer, and the output layer may have a format of a vector matrix used for matrix multiplication operation. In the input layer, first matrix multiplication, that is, first multiplying-accumulating (MAC) operation may be performed on the first vector matrix and the first weight matrix, which are the input data INPUT1, INPUT2, and INPUT3. The input layer may perform the first MAC operation to generate a second vector matrix, and transmit the generated second vector matrix to the first hidden layer. In the first hidden layer, a second matrix multiplication for the second vector matrix and the second weight matrix, that is, a second MAC operation may be performed. The first hidden layer may perform the second MAC operation to generate a third vector matrix, and transmit the generated third vector matrix to the second hidden layer. In the second hidden layer, a third matrix multiplication for the third vector matrix and the third weight matrix, that is, a third MAC operation may be performed. The second hidden layer may perform the third MAC operation to generate a fourth vector matrix, and transmit the generated fourth vector matrix to the output layer. In the output layer, a fourth matrix multiplication for the fourth vector matrix and the fourth weight matrix, that is, a fourth MAC operation may be performed. The output layer may perform the fourth MAC operation to generate final output data OUTPUT.

The first to eighth PIM devices 111-118 of FIG. 1 may perform the MLP operation of FIG. 4 by performing the first to fourth MAC operations. Hereinafter, the case of the first PIM device 111 will be taken as an example. The description below may be applied to the second to eighth PIM devices 112-118 in the same manner. In order for the first PIM device 111 to perform the first MAC operation in the input layer, the first vector data, which are elements of the first vector matrix, and first weight data, which are elements of the first weight matrix, may be provided to the first to sixteenth processing units PU0-PU15. When the first MAC operation is performed, the first to sixteenth processing units PU0-PU15 may output the second vector data that is used as input data to the first hidden layer. In order for the first PIM device 111 to perform the second MAC operation in the first hidden layer, the second vector data and the second weight data may be provided to the first to sixteenth processing units PU0-PU15. When the second MAC operation is performed, the first to sixteenth processing units PU0-PU15 may output the third vector data that is used as input data to the second hidden layer. In order for the first PIM device 111 to perform the third MAC operation, the third vector data and the third weight data may be provided to the first to sixteenth processing units PU0-PU15. When the third MAC operation is performed, the first to sixteenth processing units PU0-PU15 may output the fourth vector data that is used as input data to the output layer. In order for the first PIM device 111 to perform the fourth MAC operation in the output layer, the fourth vector data and the fourth weight data may be provided to the first to sixteenth processing units PU0-PU15. When the fourth MAC operation is performed, the first to sixteenth processing units PU0-PU15 may output the final output data OUTPUT.

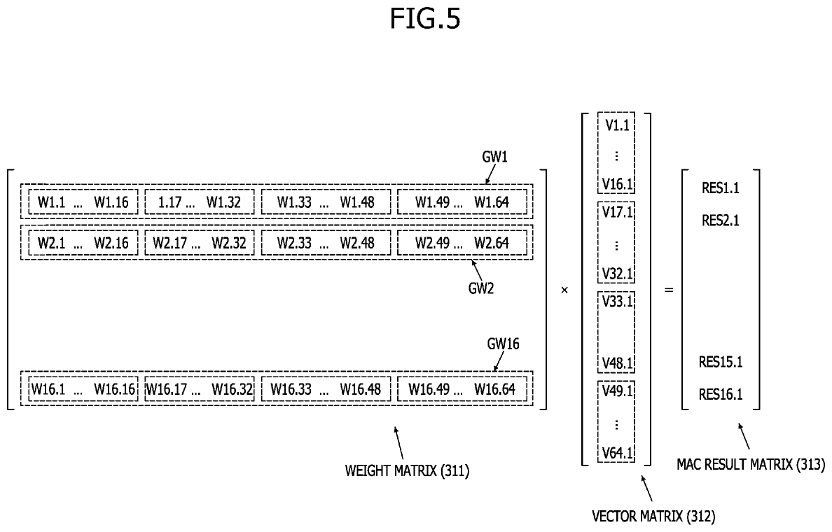

FIG. 5 is a diagram illustrating an example of the matrix multiplication operation used in the MLP operation of FIG. 4. The weight matrix 311 in FIG. 5 may be composed of weight data included in any one of the input layer, the first hidden layer, the second hidden layer, and the output layer constituting the MLP of FIG. 4. The vector matrix 312 in FIG. 5 may be composed of vector data input to any one of the input layer, the first hidden layer, the second hidden layer, and the output layer constituting the MLP of FIG. 4. In addition, the MAC result matrix 313 in FIG. 5 may be composed of result data output from any one of the input layer, the first hidden layer, the second hidden layer, and the output layer constituting the MLP of FIG. 4. Hereinafter, the case of the first PIM device 111 described with reference to FIGS. 2 and 3 will be taken as an example. The description below may be applied to the second to eighth PIM devices 112-118 in the same manner.

Referring to FIG. 5, the first PIM device 111 may perform matrix multiplication on the weight matrix 311 and the vector matrix 312 to generate the MAC result matrix 313 as a result of the matrix multiplication. The weight matrix 311 may have a format of an M×N matrix having the weight data as elements. The vector matrix 312 may have a format of an N×1 matrix having the vector data as elements. Each of the weight data and vector data may be either an integer or a floating-point number. The MAC result matrix 313 may have a format of an M×1 matrix having the MAC result data as elements. “M” and “N” may have various integer values, and in the following example, “M” and “N” are “16” and “64”, respectively.

The weight matrix 311 may have 16 rows and 64columns. That is, first to sixteenth weight data groups GW1-GW16 may be disposed in the first to sixteenth rows of the weight matrix 311, respectively. The first to sixteenth weight data groups GW1-GW16 may include first to sixteenth weight data each having 64 pieces of data. Specifically, as illustrated in FIG. 5, the first weight data group GW1 constituting the first row of the weight matrix 311 may include 64 pieces of first weight data W1.1-W1.64. The second weight data group GW2 constituting the second row of the weight matrix 311 may include 64 pieces of second weight data W2.1-W2.64. Similarly, the sixteenth weight data group GW16 constituting the sixteenth row of the weight matrix 311 may include 64 pieces of sixteenth weight data W16.1-W16.64. The vector matrix 312 may have 64 rows and one column. That is, one column of the vector matrix 312 may include 64 pieces of vector data, that is, first to 64^{th} vector data V1.1-V64.1. One column of the MAC result matrix 313 may include sixteen pieces of MAC result data RES1.1-RES16.1.

In an example, the first to sixteenth weight data groups GW1-GW16 of the weight matrix 311 may be stored in the first to sixteenth memory banks BK0-BK15, respectively. For example, the first weight data W1.1-W1.64 of the first weight data group GW1 may be stored in the first memory bank BK0. The second weight data W2.1-W2.64 of the second weight data group GW2 may be stored in the second memory bank BK1. Similarly, the sixteenth weight data W16.1-W16.64 of the sixteenth weight data group GW16 may be stored in the sixteenth memory bank BK15. Accordingly, the first processing unit PU0 may receive the first weight data W1.1-W1.64 of the first weight data group GW1 from the first memory bank BK0. The second processing unit PU1 may receive the second weight data W2.1-W2.64 of the second weight data group GW2 from the second memory bank BK1. In addition, the sixteenth processing unit PU15 may receive the sixteenth weight data W16.1-W16.64 of the sixteenth weight data group GW16 from the sixteenth memory bank BK15. The first to 64th vector data V1.1-V64.1 of the vector matrix 312 may be stored in the global buffer GB. Accordingly, the first to sixteenth processing units PU0-PU15 may receive the first to 64th vector data V1.1-V64.1 from the global buffer GB.

The first to sixteenth processing units PU0-PU15 may perform the MAC operations using the first to sixteenth weight data groups GW1-GW16 transmitted from the first to sixteenth memory banks BK0-BK15 and the vector data V1.1-V64.1 transmitted from the global buffer GB. The first to sixteenth processing units PU0-PU15 may output the result data generated by performing the MAC operations as the MAC result data RES1.1-RES64.1. The first processing unit PU0 may perform the MAC operation on the first weight data W1.1-W1.64 of the first weight data group GW1 and the vector data V1.1-V64.1 and output result data as the first MAC result data RES1.1. The second processing unit PU1 may perform the MAC operation on the second weight data W2.1-W2.64 of the second weight data group GW2 and the vector data V1.1-V64.1 and output result data as the second MAC result data RES2.1. In addition, the sixteenth processing unit PU15 may perform the MAC operation on the sixteenth weight data W16.1-W16.64 of the sixteenth weight data group GW16 and the vector data V1.1-V64.1 and output result data as the sixteenth MAC result data RES16.1.

Depending on the amount of data that can be processed by the first to sixteenth processing units PU0-PU15, the MAC operation for the weight matrix 311 and the vector matrix 312 may be divided into a plurality of sub-MAC operations and performed. Hereinafter, it is assumed that the amount of data that can be processed by the first to sixteenth processing units PU0-PU15 is 16pieces of weight data and 16 pieces of vector data. The first to sixteenth weight data constituting the first to sixteenth weight data groups GW1-GW16 may each be divided into four sets. Similarly, the first to 64th vector data V1.1-V64.1 may also be divided into four sets.

For example, the first weight data W1.1-W1.64 constituting the first weight data group GW1 may be divided into a first set W1.1-W1.16, a second set W1.17-W1.32, a third set W1.33-W1.48, and a fourth set W1.49-W1.64. The first set W1.1-W1.16 of the first weight data W1.1-W1.64 may be composed of elements of the first to sixteenth columns of the first row of the weight matrix 311. The second set W1.7-W1.32 of the first weight data W1.1-W1.64 may be composed of elements of the 17^{th} to 32^{nd} columns of the first row of the weight matrix 311. The third set W1.33-W1.48 of the first weight data W1.1-W1.64 may be composed of elements of the 33^{rd} to 48^{th} columns of the first row of the weight matrix 311. In addition, the fourth set W1.49-W1.64 of the first weight data W1.1-W1.64 may be composed of elements of the 49^{th} to 64^{th} columns of the first row of the weight matrix 311.

Similarly, the second weight data W2.1-W2.64 constituting the second weight data group GW2 may be divided into a first set W2.1-W2.16, a second set W2.17-W2.32, a third set W2.33-W2.48, and a fourth set W2.49-W2.64. The first set W2.1-W2.16 of the second weight data W2.1-W2.64 may be composed of elements of the first to sixteenth columns of the second row of the weight matrix 311. The second set W2.7-W2.32 of the second weight data W2.1-W2.64 may be composed of elements of the 17^{th} to 32^{nd} columns of the second row of the weight matrix 311. The third set W2.33-W2.48 of the second weight data W2.1-W2.64 may be composed of elements of the 33^{rd} to 48^{th} columns of the second row of the weight matrix 311. In addition, the fourth set W2.49-W2.64 of the second weight data W2.1-W2.64 may be composed of elements of the 49^{th} to 64^{th} columns of the second row of the weight matrix 311.

Similarly, the sixteenth weight data W16.1-W16.64 constituting the sixteenth weight data group GW16 may be divided into a first set W16.1-W16.16, a second set W16.17-W16.32, a third set W16.33-W16.48, and a fourth set W16.49-W16.64. The first set W16.1-W16.16 of the sixteenth weight data W16.1-W16.64 may be composed of elements of the first to sixteenth columns of the sixteenth row of the weight matrix 311. The second set W16.7-W16.32 of the sixteenth weight data W16.1-W16.64 may be composed of elements of the 17^{th} to 32^{nd} columns of the sixteenth row of the weight matrix 311. The third set W16.33-W16.48 of the sixteenth weight data W16.1-W16.64 may be composed of elements of the 33^{rd} to 48^{th} columns of the sixteenth row of the weight matrix 311. In addition, the fourth set W16.49-W16.64 of the sixteenth weight data W16.1-W16.64 may be composed of elements of the 49^{th} to 64^{th} columns of the sixteenth row of the weight matrix 311.

The first to 64^{th} vector data V1.1-V64.1 may be divided into a first set V1.1-V16.1, a second set V16.1-V32.1, a third set V33.1-V48.1, and a fourth set V49.1-V64.1. The first set V1.1-V16.1 of the vector data may be composed of elements of the first to sixteenth rows of the vector matrix 312. The second set V17.1-V32.1 of the vector data may be composed of elements of the 17^{th} to 32^{nd} rows of the vector matrix 312. The third set V33.1-V48.1 of the vector data may be composed of elements of the 33^{rd} to 48^{th} rows of the vector matrix 312. In addition, the fourth set V49.1-V64.1 of the vector data may be composed of elements of the 49^{th} to 64^{th} rows of the vector matrix 312.

Hereinafter, a MAC operation process performed by the first processing unit PU0 will be described. The MAC operation process described below may be equally applied to the MAC operation processes performed by the second to sixteenth processing units PU1-PU15. The first processing unit PU0 may perform a first sub-MAC operation on the first set W1.1-W1.16 of the first weight data and the first set V1.1-V16.1 of the vector data to generate first MAC data. The first sub-MAC operation may be performed by a multiplication on the first set W1.1-W1.16 of the first weight data and the first set V1.1-V16.1 of the vector data and an addition on multiplication result data.

A first processing unit PU0 may perform a second sub-MAC operation on the second set W1.17-W1.32 of the first weight data and the second set V17.1-V32.1 of the vector data to generate second MAC data. The second sub-MAC operation may be performed by multiplication on the second set W1.17-W1.32 of the first weight data and the second set V17.1-V32.1 of vector data, addition on multiplication result data, and accumulation on addition operation result data and the first MAC data.

The first processing unit PU0 may perform a third sub-MAC operation on the third set W1.33-W1.48 of the first weight data and the third set V33.1-V48.1 of the vector data to generate third MAC data. The third sub-MAC operation may be performed by multiplication on the third set W1.33-W1.48 of the first weight data and the third set V33.1-V48.1 of the vector data, addition on multiplication result data, and accumulation on addition result data and the second MAC data.

The first processing unit PU0 may perform a fourth sub-MAC operation on the fourth set W1.49-W1.64 of the first weight data and the fourth set V49.1-V64.1 of the vector data to generate fourth MAC data. The fourth sub-MAC operation may be performed by multiplications on the fourth set W1.49-W1.64 of the first weight data and the fourth set V49.1-V64.1 of the vector data, additions on multiplication result data, and accumulation on addition result data and the third MAC data. The fourth MAC data generated by the fourth sub-MAC operation may constitute the first MAC result data RES1.1 corresponding to an element of the first column of the result matrix 313.

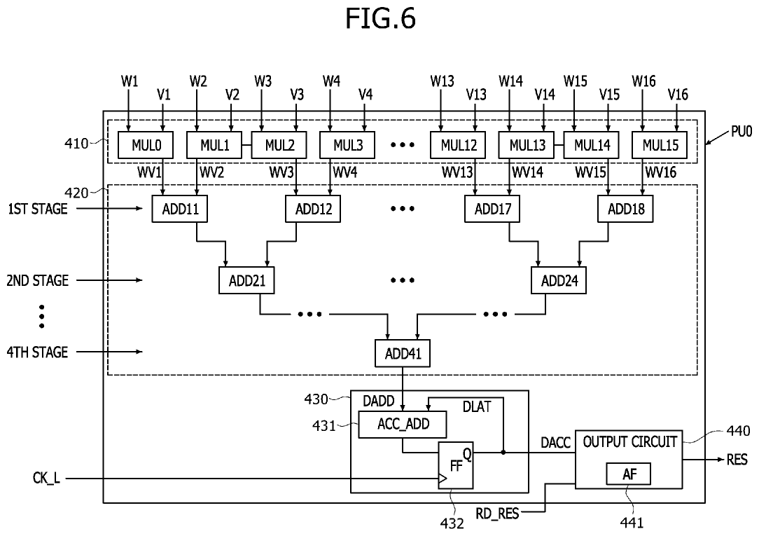

FIG. 6 is a circuit diagram illustrating an embodiment of a processing unit PU0, which may be included in a PIM device 111 depicted in FIG. 1 and FIG. 3. It is assumed that the amount of data that can be processed by the processing unit PU0 is 16 pieces of weight data and 16 pieces of vector data.

The description below may be applied to each processing unit PU PU1-PU15 included in the first PIM device 111. Moreover, the processing unit PU description may be applied to the first to sixteenth processing units PU0-PU15 included in each of the second to eighth PIM devices 112-118 of FIG. 1.

Still referring to FIG. 6, the processing unit PU0 may include a multiplication circuit 410, an addition circuit 420, an accumulation circuit 430, and an output circuit 440. The multiplication circuit 410 performs multiplication. The addition circuit 420 performs addition. The accumulation circuit 440 collects or receives multiplication and addition results. Those circuits are therefore considered herein as performing mathematical functions and mathematical operations. For claim construction purposes, however, the terms mathematical functions and mathematical operations should be construed as also including any one or more Boolean functions, examples of which include AND, OR, NOT, XOR, NOR et al., and the application or performance of a Boolean function to, or on, digital data.
The multiplication circuit 410 may be configured to receive the first to sixteenth weight data W1-W16 and the first to sixteenth vector data V1-V16. The first to sixteenth weight data W1-W16 may be provided by, i.e., obtained from, the first memory bank (BK0 of FIG. 2). The first to sixteenth vector data V1-V16 may be provided by, the global buffer (GB of FIG. 2). The multiplication circuit 410 may perform multiplications on the first to sixteenth weight data W1-W16 and the first to sixteenth vector data V1-V16 to generate and output first to sixteenth multiplication data WV1-WV16.
The first to sixteenth weight data W1-W16 and the first to sixteenth vector data V1-V16 may be the first set W1.1-W1.16 of the first weight data W1.1-W1.64 and the first set V1.1-V16.1 of the vector data V1.1-V64.1 described with reference to FIG. 5, respectively. Alternatively, the first to sixteenth weight data W1-W16 and the first to sixteenth vector data V1-V16 may be the second set W1.17-W1.32 of the first weight data W1.1-W1.64 and the second set V17.1-V32.1 of the vector data V1.1-V64.1 described with reference to FIG. 5, respectively. Alternatively, the first to sixteenth weight data W1-W16 and the first to sixteenth vector data V1-V16 may be the third set W1.33-W1.48 of the first weight data W1.1-W1.64 and the third set V33.1-V48.1 of the vector data V1.1-V64.1 described with reference to FIG. 5, respectively. Alternatively, the first to sixteenth weight data W1-W16 and the first to sixteenth vector data V1-V16 may be the fourth set W1.49-W1.64 of the first weight data W1.1-W1.64 and the fourth set V49.1-V4864.1 of the vector data V1.1-V64.1 described with reference to FIG. 5, respectively.

As FIG. 6, shows, the multiplication circuit 410 may include a plurality of multipliers, for example, first to sixteenth multipliers MUL0-MUL15. The first to sixteenth multipliers MUL0-MUL15 may receive first to sixteenth weight data W1-W16, respectively, and first to sixteenth vector data V1-V16.

The first to sixteenth multipliers MUL0-MUL15 may perform multiplications on the first to sixteenth weight data W1-W16 by the first to sixteenth vector data V1-V16, respectively. The first to sixteenth multipliers MUL0-MUL15 may output data generated as a result of the multiplications as the first to sixteenth multiplication data WV1-WV16, respectively. For example, the first multiplier MUL0 may perform a multiplication of the first weight data W1 and the first vector data V1 to output the first multiplication data WV1. The second multiplier MUL1 may perform a multiplication of the second weight data W2 and the second vector data V2 to output the second multiplication data WV2. In the same manner, the remaining multipliers MUL2-MUL15 may also output the third to sixteenth multiplication data WV3-WV16, respectively. The first to sixteenth multiplication data WV1-WV16 output from the multipliers MUL0-MUL15 may be transmitted to the addition circuit 420.

The addition circuit 420 may be configured by arranging a plurality of adders ADDERs in a hierarchical structure such as a tree structure. The addition circuit 420 may be composed of half-adders as well as full-adders. Eight adders ADD11-ADD18 may be disposed in a first stage of the addition circuit 420. Four adders ADD21-ADD24 may be disposed in the next lower second stage of the addition circuit 420. Not shown in FIG. 6 is that two adders may be disposed in the next-lower third stage of the addition circuit 420. One adder ADD41 may be disposed in a fourth stage at the lowest level of the addition circuit 420.

Each first stage adder ADD11-ADD18 may receive multiplication data WVs from two multipliers of the first to sixteenth multipliers MUL0-MUL15 of the multiplication circuit 410. Each first stage adder ADD11-ADD18 may perform an addition on the input multiplication data WVs to generate and output addition data. For example, the adder ADD11 of the first stage may receive the first and second multiplication data WV1 and WV2 from the first and second multipliers MUL0 and MUL1, and perform an addition on the first and second multiplication data WV1 and WV2 to output addition result data. In the same manner, the adder ADD18 of the first stage may receive the fifteenth and sixteenth multiplication data WV15 and WV16 from the fifteenth and sixteenth multipliers MUL14 and MUL15, and perform an addition on the fifteenth and sixteenth multiplication data WV15 and WV16 to output addition result data.

Each second stage adder ADD21-ADD24 may receive the addition result data from two first stage adders ADD11-ADD18 and perform an addition on the addition result data to output addition result data. For example, the second stage adder ADD21 may receive the addition results from first stage adders ADD11 and ADD12. The addition result data output from the second stage adder ADD21 may therefore have a value obtained by adding all of the first to fourth multiplication data WV1 to WV4. In this way, the fourth stage adder ADD41 may therefore perform an addition of the addition results from two third-stage to generate and output, multiplication addition data DADD, which is data that is output from the addition circuit 420. The multiplication addition data DADD output from the addition circuit 420 may be transmitted to the accumulation circuit 430.

As used herein and the context in which it is used, the word “latch” may refer to a device, which may retain or hold data. “Latch” may also refer to an action or a method by which a data is stored, retained or held. As used herein, the term “accumulative addition” refers to a running and accumulating sum (addition) of a sequence of partial sums of a data set. An accumulative addition may be used to show the summation of data over time.

In FIG. 6, the accumulation circuit 430 may perform an accumulative addition of multiplication addition data DADD transmitted by (also received from) the addition circuit 420 and, DLAT data that is output from latch 432, the DLAT data being referred to as latch data DLAT, in order to generate accumulation data DACC. The accumulation circuit 430 may latch or store the accumulation data DACC to output latched accumulation data DACC as the latch data DLAT. In an example, the accumulation circuit 430 may include an accumulative adder (ACC_ADD) 431 and a latch circuit (FF) 432. The accumulative adder 431 may receive the multiplication addition data DADD from the addition circuit 420. The accumulative adder 431 may receive the latch data DLAT generated by the previous sub-MAC operation. The accumulative adder 431 may perform an accumulative addition on the multiplication addition data DADD and the latch data DLAT to generate and output the accumulation data DACC. The accumulation data DACC output from the accumulative adder 431 may be transmitted to an input terminal of the latch circuit 432. The latch circuit 432 may latch and output the accumulation data DACC transmitted from the accumulative adder 431 in synchronization with a clock signal CK_L. The accumulation data DACC output from the latch circuit 432 may be provided to the accumulative adder 431 as the latch data DLAT in the next sub-MAC operation. In addition, the accumulation data DACC output from the latch circuit 432 may be transmitted to the output circuit 440.

The output circuit 440 may output accumulation data DACC, or may output inverted accumulation data DACC; which is transmitted from the latch circuit 432 of the accumulation circuit 430 depending on a logic level of a resultant read signal RD_RES. In an example, when the MAC operation described with reference to FIG. 5 is performed, the accumulation data DACC transmitted from the latch circuit 432 of the accumulation circuit 430 in the fourth sub-MAC operation process may constitute the MAC result data RES. In such a case, the resultant read signal RD_RES of a logic “high” level may be transmitted to the output circuit 440. The output circuit 440 may output the accumulation data DACC as the MAC result data RES in response to the resultant read signal RD_RES of a logic “high” level.

On the other hand, the accumulation data DACC transmitted from the latch circuit 432 of the accumulation circuit 430 in any one of the first to third sub-MAC operation processes might not constitute the MAC result data RES. In such a case, the resultant read signal RD_RST of a logic “low” level may be transmitted to the output circuit 440. The output circuit 440 might not output the accumulation data DACC as the MAC result data RES in response to the resultant read signal RD_RES of the logic “low” level. Although not shown in FIG. 6, the output circuit 440 may include an activation function circuit (AF) 441 that applies an activation function signal to the accumulation data DACC. In an example, the output circuit 430 may transmit the MAC result data RES or the MAC result data processed with the activation function to the PIM network system (120 of FIG. 1). In another example, the output circuit 430 may transmit the MAC result data RES or the MAC result data processed with the activation function to the memory banks.

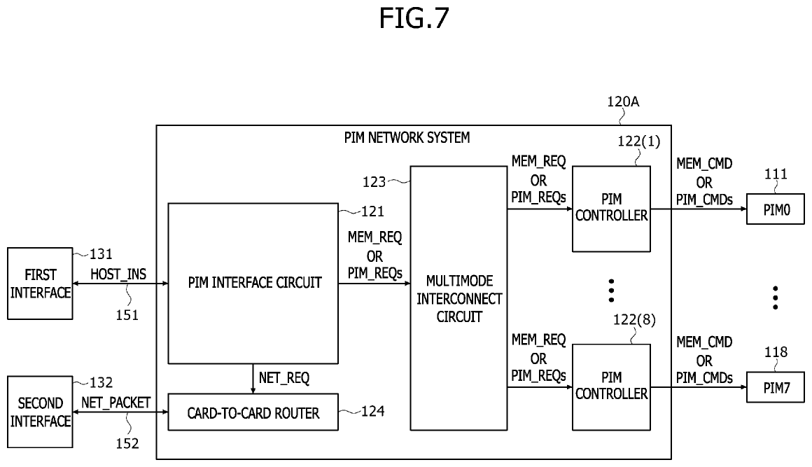

FIG. 7 is a block diagram illustrating an example of the PIM network system 120 included in the PIM-based accelerating device 100 of FIG. 1. Referring to FIG. 7, a PIM network system 120A according to an example may include a PIM interface circuit 121, a multimode interconnect circuit 123, a plurality of PIM controllers, for example, first to eighth PIM controllers 122(1)-122(8), and a card-to-card router 124.

The PIM interface circuit 121 may be coupled to a first interface 131 through a first interface bus 151. Accordingly, the PIM interface circuit 121 may receive a host instruction HOST_INS from a host device through the first interface 131 and the first interface bus 151. Although not shown in FIG. 7, the PIM interface circuit 121 may receive data as well as the host instruction HOST_INS from the host device through the first interface 131 and the first interface bus 151. In addition, the PIM interface circuit 121 may transmit the data to the host device through the first interface 131 and the first interface bus 151. The PIM interface circuit 121 may process the host instruction HOST_INS to generate and output a memory request MEM_REQ, a plurality of PIM requests PIM_REQs, or a network request NET_REQ. As a result of processing the host instruction HOST_INS, one memory request MEM_REQ may be generated, but a plurality of memory requests MEM_REQs may be generated in some cases. Hereinafter, a case in which one memory request MEM_REQ is generated will be described. The PIM interface circuit 121 may transmit the memory request MEM_REQ or the plurality of PIM requests PIM_REQs to the multimode interconnect circuit 123. The PIM interface circuit 121 may transmit the network request NET_REQ to the card-to-card router 124.

As used herein, “unicast” refers to a transmission mode in which a single message is sent to a single “network” destination, (i.e., one-to-one). “Broadcast” refers to a transmission mode in which a single message is sent to all “network” destinations. “Multicast” refers to a transmission mode in which a single message is sent to multiple “network” destinations but not necessarily all destinations.

The multimode interconnect circuit 123 may transmit the memory request MEM_REQ or the plurality of PIM requests PIM_REQs transmitted from the PIM interface circuit 121 to at least one PIM controller among first to eighth PIM controllers 122(1)-122(8). In an example, the multimode interconnect circuit 123 may operate in any one mode among a unicast mode, a multicast mode, and a broadcast mode.

Each of the first to eighth PIM controllers 122(1)-122(8) may generate at least one memory command MEM_CMD corresponding to the memory request MEM_REQ transmitted from the multimode interconnect circuit 123. In addition, each of the first to eighth PIM controllers 122(1)-122(8) may generate a plurality of PIM commands PIM_CMDs corresponding to the plurality of PIM requests PIM_REQs transmitted from the multimode interconnect circuit 123. The first to eighth PIM controllers 122(1)-122(8) may transmit the memory command MEM_CMD or the plurality of PIM commands PIM_CMDs to the first to eighth PIM devices 111-118, respectively. The first to eighth PIM controllers 122(1)-122(8) may be allocated to the first to eighth PIM devices 111-118, respectively. For example, the first PIM controller 122(1) may be allocated to the first PIM device 111. Accordingly, the first PIM controller 122(1) may transmit the memory command MEM_CMD or the plurality of PIM commands PIM_CMDs to the first PIM device 111. Similarly, the eighth PIM controller 122(8) may be allocated to the eighth PIM device 118. Accordingly, the eighth PIM controller 122(8) may transmit the memory command MEM_CMD or the plurality of PIM commands PIM_CMDs to the eighth PIM device 118.

The card-to-card router 124 may be coupled to the second interface 132 through the second interface bus 152. The card-to-card router 124 may transmit a network packet NET_PACKET to the second interface 132 through the second interface bus 152, based on the network request NET_REQ transmitted from the PIM interface circuit 121. The card-to-card router 124 may process the network packet NET_PAPCKET transmitted from another PIM-based accelerating device or a network router through the second interface 132 and the second interface bus 152. In this case, although not shown in FIG. 7, the card-to-card router 124 may transmit the network packet NET_PACKET to the multimode interconnect circuit 123. In an example, the card-to-card router 124 may include a network controller.

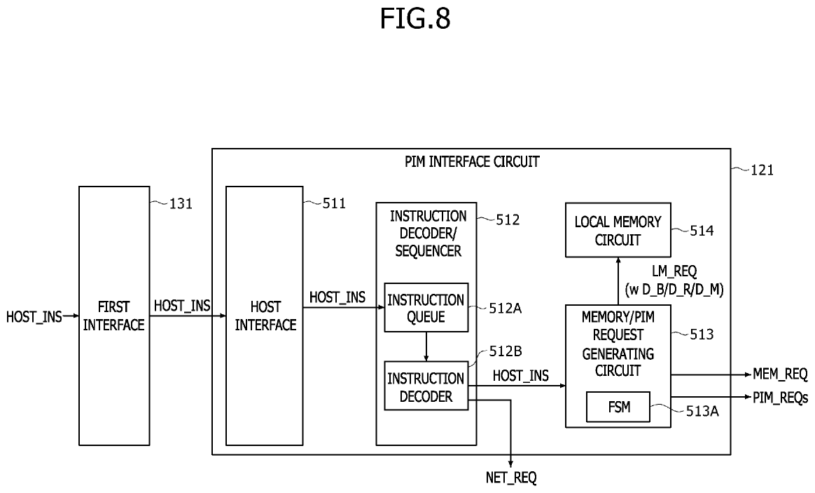

FIG. 8 is a block diagram illustrating an example of a PIM interface circuit 121 depicted in the PIM network system 120A of FIG. 7. The PIM interface circuit 121 may include a host interface 511, an instruction decoder/sequencer 512, a memory/PIM request generating circuit 513, and a local memory circuit 514.

The host interface 511 may receive the host instruction HOST_INS from the host device through the first interface 131. The host interface 511 may be configured according to a high-speed interfacing protocol employed by the first interface 131. For example, when the host interface 511 adopts the PCIe standard, the host interface 511 may include an interface master and an interface slave, such as an advanced extensible interface (AXI) master and an AXI slave, respectively. The host interface 511 may transmit the host instruction HOST_INS transmitted from the first interface 131 to the instruction decoder/sequencer 512. Although not shown in FIG. 8, the host interface 511 may include a direct memory access (DMA) device, which is capable of directly accessing the main memory without going through a host device processor.

It is our experience that “queue” almost always refers to a list. In the following paragraphs, however, the word “queue” seems to refer to structure because it is shown in FIG. 8 as being part of the decoder/sequencer 512, which is almost certainly a structure. In order to avoid a rejection under 35 USC 112, we added a definition of “queue” in the following paragraph. We defined “queue” as referring to either a list or a device, the difference being determinable from the context in which the word is used.

The word “queue” may refer to a list in which data items are appended to the last position of the list and retrieved from the first position of the list. Depending on the context in which “queue” is used, however, “queue” it may also refer to a device, e.g., memory, in which data items may be appended to the last position of a list of items stored in the device and retrieved from the first position of the list of stored items.

In FIG. 8, the instruction decoder/sequencer 512 may include an instruction queue device 512A and an instruction decoder 512B. The instruction queue device 512A may store the host instruction HOST_INS transmitted from the host interface 511. The instruction decoder 512B may receive the host instruction HOST_INS from the instruction queue 512A, and perform decoding on the host instruction HOST_INS. The instruction decoder 512B may determine whether the host instruction HOST_INS is a request for memory access or PIM operation, or is a host instruction HOST_INS for network process. In an example, the memory access may include access to the first to sixteenth memory banks (BK0-BK15 in FIGS. 2 and 3) included in each of the first to eighth PIM devices (111-118 in FIG. 1) and access to the local memory circuit 514. As a result of decoding the host instruction HOST_INS, when the host instruction HOST_INS is related to memory access or PIM operation, the instruction decoder 512B may transmit the host instruction HOST_INS to the memory/PIM request generating circuit 513. As a result of decoding the host instruction HOST_INS, when the host instruction HOST_INS is related to network processing, the instruction decoder 512B may generate the network request NET_REQ corresponding to the host instruction HOST_INS, and transmit the network request NET_REQ to the card-to-card router (124 in FIG. 7).

The memory/PIM request generating circuit 513 may generate and output at least one memory request MEM_REQ, the plurality of PIM requests PIM_REQs, or the local memory request LM_REQ, based on the host instruction HOST_INS transmitted from the instruction decoder/sequencer 512. In an example, the memory request MEM_REQ may request a read operation or a write operation for the first to sixteenth memory banks (BK0-BK15 of FIG. 2 and FIG. 3) included in each of the first to eighth PIM devices (111-118 of FIG. 1). The plurality of PIM requests PIM_REQs may request an operation in the first to eighth PIM devices (111-118 of FIG. 7). The local memory request LM_REQ may request an operation of storing or reading bias data D_B, operation result data D_R, and maintenance data D_M in the local memory circuit 514. In an example, the bias data D_B may be used in a process in which the operation operations are performed in the first to eighth PIM devices (111-118 in FIG. 7). In an example, the operation result data D_R may be data generated by the operation operations in the first to eighth PIM devices (111-118 in FIG. 7). In an example, the maintenance data D_M may be data for diagnosing and debugging for the first to eighth PIM devices (111-118 in FIG. 7). In an example, the bias data D_B, the operation result data D_R, and the maintenance data D_M may be transmitted from the memory/PIM request generating circuit 513 to the local memory circuit 514 as included in the local memory request LM_REQ.

In an example, the memory/PIM request generating circuit 513 may generate and output the memory request MEM_REQ, the plurality of PIM requests PIM_REQs, or the local memory request LM_REQ, based on a finite state machine (hereinafter, referred to as “FSM”) 513A. In this case, data included in the host instruction HOST_INS may be used as an input value to the FSM 513A. The memory/PIM request generating circuit 513 may transmit the memory request MEM_REQ or the plurality of PIM requests PIM_REQs to the multimode interconnect circuit (123 in FIG. 7). The memory/PIM request generating circuit 513 may transmit the local memory request LM_REQ to the local memory circuit 514. In an example, the FSM 513A may be replaced with a programmable programming device that takes the host instruction HOST_INS as an input value and the memory request MEM_REQ and the PIM requests PIM_REQs as output values. In this case, the programming device may be reprogrammed by firmware.

The local memory circuit 514 may perform a local memory operation, based on the local memory request LM_REQ transmitted from the memory/PIM request generating circuit 513. In an example, the local memory circuit 514 may store the bias data D_B, the operation result data D_R, and the maintenance data D_M transmitted together with the local memory request LM_REQ. In addition, the local memory circuit 514 may return the stored bias data D_B, the operation result data D_R, and the maintenance data D_M to the memory/PIM request generating circuit 513, based on the local memory request LM_REQ. In an example, the local memory circuit 513 may include a static random access memory (SRAM) device.

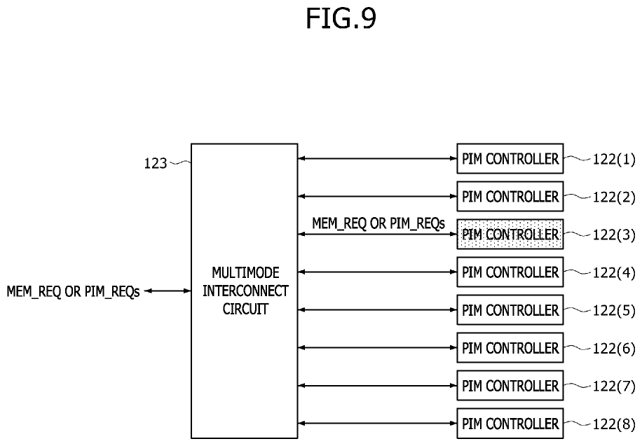

FIGS. 9 to 11 are diagrams illustrating an operation of the multimode interconnect circuit 123 included in the PIM network system 120A of FIG. 7.

First, as shown in FIG. 9, when the multimode interconnect circuit 123 operates in the unicast mode, the multimode interconnect circuit 123 may transmit the memory request MEM_REQ or the plurality of PIM requests PIM_REQs transmitted from the PIM interface circuit (121 of FIG. 7) to one PIM controller among the first to eighth PIM controllers 122(1)-122(8). As illustrated in FIG. 9, the multimode interconnect circuit 123 may transmit the memory request MEM_REQ or the plurality of PIM requests PIM_REQs to the third PIM controller 122(3), and might not transmit the memory request MEM_REQ or the plurality of PIM requests PIM_REQs to the first, second, and fourth to eighth PIM controllers 122(1), 122(2), and 122(4)-122(8).

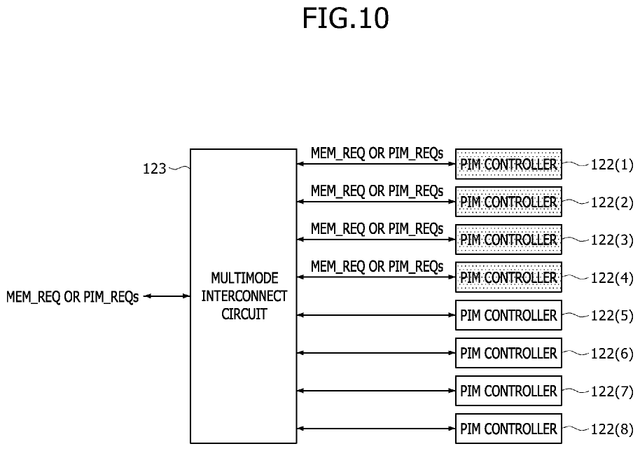

Next, as shown in FIG. 10, when the multimode interconnect circuit 123 operates in the multicast mode, the multimode interconnect circuit 123 may transmit the memory request MEM_REQ or the plurality of PIM requests PIM_REQs transmitted from the PIM interface circuit 121 to some PIM controllers among the first to eighth PIM controllers 122(1)-122(8). As illustrated in FIG. 9, the multimode interconnect circuit 123 may transmit the memory request MEM_REQ or the plurality of PIM requests PIM_REQs to the first to fourth PIM controllers 122(1)-122(4), and might not transmit the memory request MEM_REQ or the plurality of PIM requests PIM_REQs to the fifth to eighth PIM controllers 122(5)-122(8).

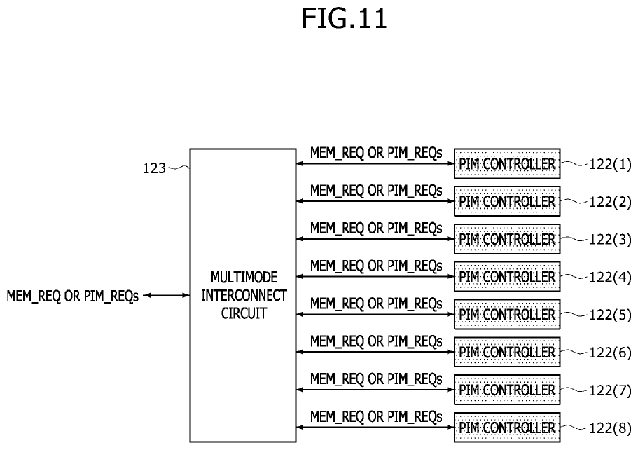

Next, as shown in FIG. 11, when the multimode interconnect circuit 123 operates in the broadcast mode, the multimode interconnect circuit 123 may transmit the memory request MEM_REQ or the plurality of PIM requests PIM_REQs transmitted from the PIM interface circuit 121 to all PIM controllers, that is, the first to eighth PIM controllers 122(1)-122(8).

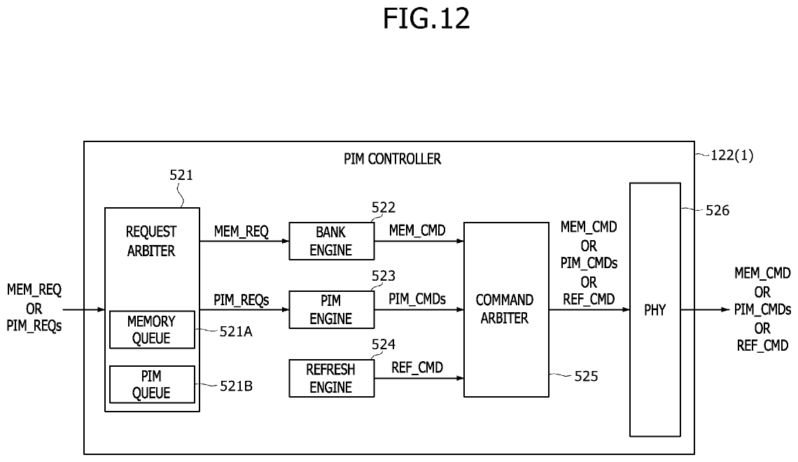

As used herein, “arbiter” refers to a device or a method, which accepts bus requests from bus-requesting devices or methods (modules) and grants control of a bus to one requester at a time. “Physical layer” refers to the layer of the ISO Reference Model that provides mechanical, electrical, functional, and procedural characteristic access required for a transmission medium. FIG. 12 is a block diagram illustrating an example of the first PIM controller 122(1) included in the PIM network system 120 of FIG. 7. The description of the first PIM controller 122(1) below may be equally applied to the second to eighth PIM controllers 122(2)-122(8). Referring to FIG. 12, the first PIM controller 122(1) may include a request arbiter 521, a bank engine 522, a PIM engine 523, a refresh engine 524, a command arbiter 525, and a physical layer 526.

The request arbiter 521 may store the memory request MEM_REQ or the plurality of PIM requests PIM-REQs transmitted from the multimode interconnect circuit (123 of FIG. 7). To this end, the request arbiter 521 may include a memory queue 521A storing the memory request MEM_REQ, and a PIM queue 521B storing the plurality of PIM requests PIM_REQs. The request arbiter 521 may transmit the memory request MEM_REQ stored in the memory queue 521A to the bank engine 522. The request arbiter 521 may transmit the plurality of PIM requests PIM_REQs stored in the PIM queue 521B to the PIM engine 523. The request arbiter 521 may output the memory request MEM_REQ and the plurality of PIM requests PIM_REQs, one-request-at-time, in an order determined by scheduling. In an example, the request arbiter 521 may perform scheduling such that memory requests MEM_REQ are output in the order determined by the re-order method, for example, the first ready-first come first serve (FR-FCFS) method. In this case, the request arbiter 521 may output the memory request MEM_REQ in the order in which the number of row activations of the memory banks is minimized while searching for the oldest entry in the memory queue 521A. On the other hand, for the plurality of PIM requests PIM_REQs, the request arbiter 521 may perform scheduling so that the plurality of PIM requests PIM_REQs are output in the in-order method, that is, in the order in which the plurality of PIM requests PIM_REQs are input to the request arbiter 521.

The bank engine 522 may generate and output the memory command MEM_CMD corresponding to the memory request MEM_REQ transmitted from the request arbiter 521. In an example, the memory command MEM_CMD generated by the bank engine 522 may include a pre-charge command, an activation command, a read command, and a write command.

The PIM engine 523 may generate and output a plurality of PIM commands PIM_CMDs corresponding to the plurality of PIM requests PIM_REQs transmitted from the request arbiter 521. In an example, the plurality of PIM commands PIM_CMDs generated by the PIM engine 523 may include an activation command for the memory banks, MAC operation commands, an activation function command, an element-wise multiplication command, a data copy command from the memory bank to the global buffer, a data copy command from the global buffer to the memory banks, a write command to the global buffer, a read command for MAC result data, a read command for MAC result data processed with activation function, and a write command for the memory banks. In this case, the activation command for the memory banks may target some memory banks among the plurality of memory banks or may target all memory banks. The activation command for the memory banks may be generated for read and write operations on the weight data, or may be generated for read and write operations on activation function data. The MAC operation commands may be divided into a MAC operation command for a single memory bank, a MAC operation command for some memory banks, and a MAC operation command for all memory banks.

The refresh engine 524 may generate and output a refresh command REF_CMD. The refresh engine 524 may generate the refresh engine REF_CMD at regular intervals. The refresh engine 524 may perform scheduling for the generated refresh command REF_CMD.

The command arbiter 525 may receive the memory command MEM_CMD output from the bank engine 522, the plurality of PIM commands PIM_CMDs output from the PIM engine 523, and the refresh command REF_CMD output from the refresh engine 524. The command arbiter 525 may perform a multiplexing operation on the memory command MEM_CMD, the plurality of PIM commands PIM_CMDs, and the refresh command REF_CMD so that the command with priority is output first.

The physical layer 526 may transmit the memory command MEM_CMD, the plurality of PIM commands PIM_CMDs, and the refresh command REF_CMD transmitted from the command arbiter 525 to the first PIM device (111 in FIG. 1). In an example, the physical layer 526 may include a packet handler that processes packets constituting the memory command MEM_CMD, plurality of PIM commands PIM_CMDs, and refresh command REF_CMD, an input/output structure for receiving and transmitting data, a calibration handler for a calibration operation, and a modulation coding scheme device. In an example, the input/output structure may employ a configurable source-synchronous interface structure, for example, a select IO structure.

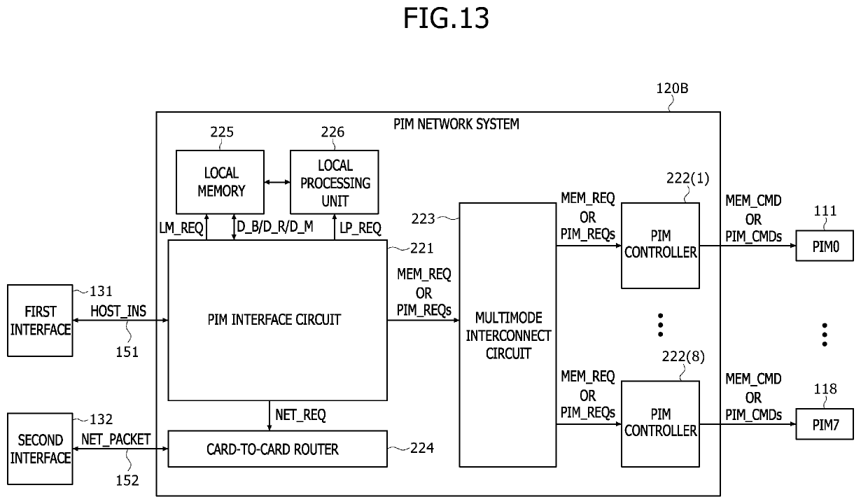

FIG. 13 is a block diagram illustrating another example of the PIM network system 120 included in the PIM-based accelerating device 100 of FIG. 1. Referring to FIG. 13, a PIM network system 120A according to another example may include a PIM interface circuit 221, a multimode interconnect circuit 223, a plurality of PIM controllers, for example, first to eighth PIM controllers 222(1)-222(8), a card-to-card router 224, a local memory 225, and a local processing unit 226. In FIG. 13, the same reference numerals as those in FIG. 8 denote the same components, and duplicate descriptions will be omitted below.

The PIM interface circuit 221 may be coupled to a first interface 131 through a first interface bus 151. Accordingly, the PIM interface circuit 221 may receive a host instruction HOST_INS from a host device through the first interface 131 and the first interface bus 151. Although not shown in FIG. 13, the PIM interface circuit 221 may receive data together with the host instruction HOST_INS from the host device through the first interface 131 and the first interface bus 151. In addition, the PIM interface circuit 221 may transmit data to the host device through the first interface 131 and the first interface bus 151. The PIM interface circuit 221 may process the host instruction HOST_INS to generate and output a memory request MEM_REQ, a plurality of PIM requests PIM_REQs, a network request NET_REQ, a local memory request LM_REQ, or a local processing request LP_REQ. The PIM interface circuit 221 may transmit the memory request MEM_REQ or the plurality of PIM requests PIM_REQs to the multimode interconnect circuit 223. The PIM interface circuit 221 may transmit the network request NET_REQ to the card-to-card router 224. The PIM interface circuit 221 may transmit the local memory request LM_REQ to the local memory 225. The PIM interface circuit 221 may transmit bias data D_B, operation result data D_R, and maintenance data D_M to the local memory 225 together with the local memory request LM_REQ. The PIM interface circuit 221 may transmit the local processing request LP_REQ to the local processing unit 226.

The multimode interconnect circuit 223 may transmit the memory request MEM_REQ or the plurality of PIM requests PIM_REQs transmitted from the PIM interface circuit 221 to at least one PIM controller among the first to eighth PIM controllers 222(1)-222(8). In an example, the multimode interconnect circuit 223 may operate in any one of the unicast mode, the multicast mode, and the broadcast mode, as described with reference to FIGS. 9 to 11.

The first to eighth PIM controllers 222(1)-222(8) may generate at least one memory command MEM_CMD corresponding to the memory request MEM_REQ transmitted from the multimode interconnect circuit 222. In addition, each of the first to eighth PIM controllers 222(1)-222(8) may generate a plurality of PIM commands PIM_CMDs corresponding to the plurality of PIM requests PIM_REQs transmitted from the multimode interconnect circuit 223. The first to eighth PIM controllers 222(1)-222(8) may transmit the memory command MEM_CMD or the plurality of PIM commands PIM_CMDs to the first to eighth PIM devices 111-118, respectively. The first to eighth PIM controllers 222(1)-222(8) may be allocated to first to eighth PIM devices 111-118, respectively. For example, the first PIM controller 222(1) may be allocated to the first PIM device 111. Accordingly, the first PIM controller 222(1) may transmit the memory command MEM_CMD or the plurality of PIM commands PIM_CMDs to the first PIM device 111. Similarly, the eighth PIM controller 222(8) may be allocated to the eighth PIM device 118. Accordingly, the eighth PIM controller 222(8) may transmit the memory command MEM_CMD or the plurality of PIM commands PIM_CMDs to the eighth PIM device 118. The description of the first PIM controller 122(1) described with reference to FIG. 12 may be equally applied to the second to eighth PIM controllers 222(2)-222(8).

The card-to-card router 224 may be coupled to a second interface 132 through a second interface bus 152. The card-to-card router 224 may transmit a network packet NET_PACKET to the second interface 132 through the second interface bus 152, based on the network request NET_REQ transmitted from the PIM interface circuit 221. The card-to-card router 224 may process the network packets NET_PACKETs transmitted from another PIM-based accelerating device or a network router through the second interface 132 and the second interface bus 152. In this case, although not shown in FIG. 13, the card-to-card router 224 may transmit the network packet NET_PACKET to the multimode interconnect circuit 223. In an example, the card-to-card router 224 may include a network controller.

The local memory 225 may receive the local memory request LM_REQ from the PIM interface circuit 221. Although not shown in FIG. 13, the local memory 225 may exchange data with the PIM interface circuit 221. In an example, the local memory 225 may store bias data D_B provided to the first to sixteenth processing units (PU0-PU15 in FIGS. 2 and 3) included in each of the first to eighth PIM devices, and transmit the stored bias data D_B to the PIM interface circuit 221. The local memory 225 may store operation result data (or operation result data processed with an activation function) D_R generated by the first to sixteenth processing units (PU0-PU15 of FIGS. 2 and 3) included in each of the first to eighth PIM devices, and transmit the stored operation result data D_R to the PIM interface circuit 221. The local memory 225 may store temporary data exchanged between the first to eighth PIM devices (111-118 of FIG. 1). In addition, the local memory 225 may store maintenance data D_M for diagnosis and debugging, such as temperature, and transmit the stored maintenance data D_M to the PIM interface circuit 221. The local memory 225 may provide the stored data to the local processing unit 226, and receive and store data from the local processing unit 226. In an example, the local memory 225 may include SRAM device.

The local processing unit 226 may receive the local processing request LP_REQ from the PIM interface circuit 221. The local processing unit 226 may perform local processing designated by the local processing request LP_REQ in response to the local processing request LP_REQ. To this end, the local processing unit 226 may receive data required for the local processing from the PIM interface circuit 221 or the local memory 225. The local processing unit 226 may transmit result data generated by the local processing to the local memory 225.

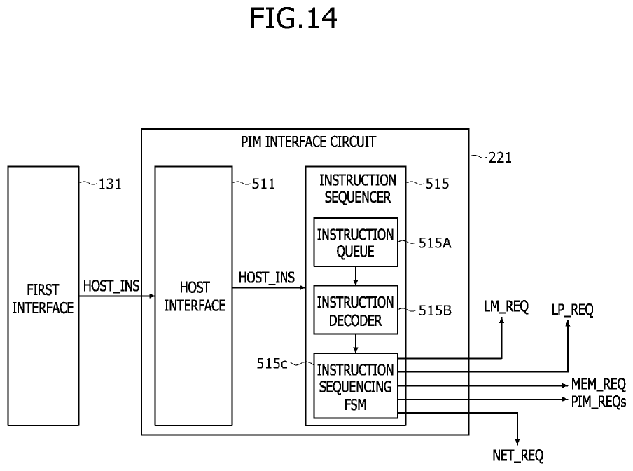

FIG. 14 is a block diagram illustrating an example of the PIM interface circuit 221 included in the PIM network system 120B of FIG. 13. Referring to FIG. 14, the PIM interface circuit 221 may include a host interface 511 and an instruction sequencer 515.

The host interface 511 may receive the host instruction HOST_INS from the first interface 131. As described with reference to FIG. 8, the host interface 511 may adopt the PCIe standard, the CXL standard, or the USB standard. Although omitted from FIG. 14, the host interface 511 may include a DMA device.

The instruction sequencer 515 may generate and output a memory request MEM_REQ, PIM requests PIM_REQs, a network request NET_REQ, a local memory request M_REQ, or a local processing request LP_REQ, based on the host instruction HOST_INS transmitted from the host interface 511. The instruction sequencer 515 may include an instruction queue 515A, an instruction decoder 515B, and an instruction sequencing FSM 515C. The instruction queue 515A may store the host instruction HOST_INS transmitted from the host interface 511. The instruction queue 515A may decode the stored host instruction HOST_INS to transmit decoded host instruction to the instruction sequencing FSM 515C. The instruction sequencing FSM 515C may generate and output the memory request MEM_REQ, the PIM requests PIM_REQs, the network request NET_REQ, the local memory request LM_REQ, or the local processing request LP_REQ, based on decoding result of the host instruction HOST_INS. The instruction sequencing FSM 515C may transmit the memory request MEM_REQ and the PIM requests PIM_REQs to the multimode interconnect circuit (223 in FIG. 13). The instruction sequencing FSM 515C may transmit the network request NET_REQ to the card-to-card router (224 of FIG. 13). The instruction sequencing FSM 515C may transmit the local memory request LM_REQ to the local memory (225 of FIG. 13). The instruction sequencing FSM 515C may transmit the local processing request LP_REQ to the local processing unit (226 of FIG. 13). In an example, the instruction sequencing FSM 515C may be replaced with a programmable programming device. In this case, the programming device may be reprogrammed by firmware.

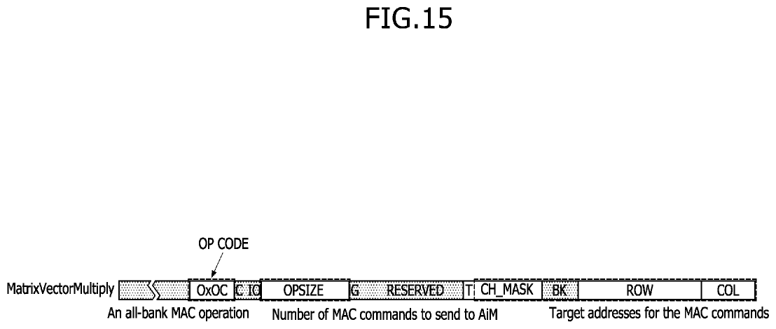

FIG. 15 is a diagram illustrating an example of the host instruction transmitted from a host device to a PIM-based accelerating device 100 according to the present disclosure.

Referring to FIG. 15, a host instruction MatrixVectorMultiply requesting a matrix vector multiplication for all memory banks may include a command code OP CODE designating the MAC operation for all memory banks, a command size OPSIZE designating the number of MAC commands to be transmitted to the PIM device, a channel mask CH_MASK as a target address for the MAC commands, a bank address BK, a row address ROW, and a column address COL. In the example of FIG. 15, an example in which “0x0C” is mapped as the command code OP CODE is presented. The channel mask CH_MASK may designate a channel through which the MAC commands are transmitted.

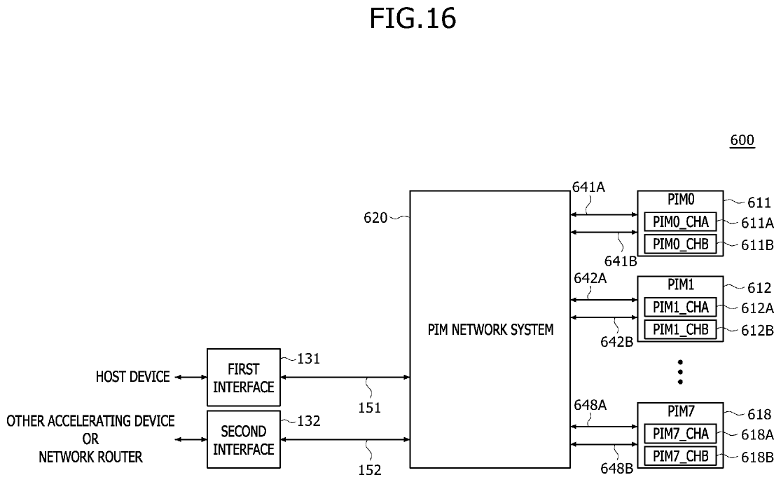

FIG. 16 is a diagram illustrating a PIM-based accelerating device 600 according to another embodiment of the present disclosure. In FIG. 16, the same reference numerals as those in FIG. 1 denote the same components, and duplicate descriptions will be omitted below.

Referring to FIG. 16, the PIM-based accelerating device 600 may include a plurality of PIM devices, for example, first to eighth PIM devices (PIM0-PIM7) 611-618, and a PIM network system 620 controlling traffic of signals and data for the first to eighth PIM devices 611-618. In addition, as described above with reference to FIG. 1, the PIM-based accelerating device 600 may include a first interface 131 coupled to a host device, and a second interface 132 coupled to another PIM-based accelerating device or a network router. The first interface 131 may be coupled to the PIM network system 620 through the first interface bus 151. The second interface 132 may be coupled to the PIM network system 620 through a second interface bus 152.

The first to eighth PIM devices 611-618 may include PIM devices each constituting a first channel CH_A (hereinafter, referred to as “first to eighth channel A-PIM devices”) and PIM devices each constituting a second channel CH_B (hereinafter, referred to as “first to eighth channel B-PIM devices”). In this example, the first to eighth PIM devices 611-618 include the first to eighth channel A-PIM devices and the first to eighth channel B-PIM devices constituting two channels, but this is just one example, and the first to eighth PIM devices 611-618 may include three or more channel-PIM devices each constituting three or more channels. In another example, each of the first to eighth channel A-PIM devices and each of the first to eighth channel B-PIM devices may include a plurality of ranks.

The first channel A-PIM device (PIM0-CHA) 611A of the first PIM device 611 may be coupled to the PIM network system 620 through a first channel A signal/data line 641A. The first channel B-PIM device (PIM0-CHB) 611B of the first PIM device 611 may be coupled to the PIM network system 620 through a first channel B signal/data line 641B. The second channel A-PIM device (PIM1-CHA) 612A of the second PIM device 612 may be coupled to the PIM network system 620 through a second channel A signal/data line 642A. The second channel B-PIM device (PIM1-CHB) 612B of the second PIM device 612 may be coupled to the PIM network system 620 through a second channel B signal/data line 642B. Similarly, the eighth channel A-PIM device (PIM7-CHA) 618A of the eighth PIM device 618 may be coupled to the PIM network system 620 through an eighth channel A signal/data line 648A. The eighth channel B-PIM device (PIM7-CHB) 618B of the eighth PIM device 618 may be coupled to the PIM network system 620 through an eighth channel B signal/data line 648B. Each of the first to eighth channel-A PIM devices 611A-618A and each of the first to eighth channel B-PIM devices 611B-618B may be configured the same as the PIM device (111 of FIG. 2 and FIG. 3) described with reference to FIGS. 2 and 3.

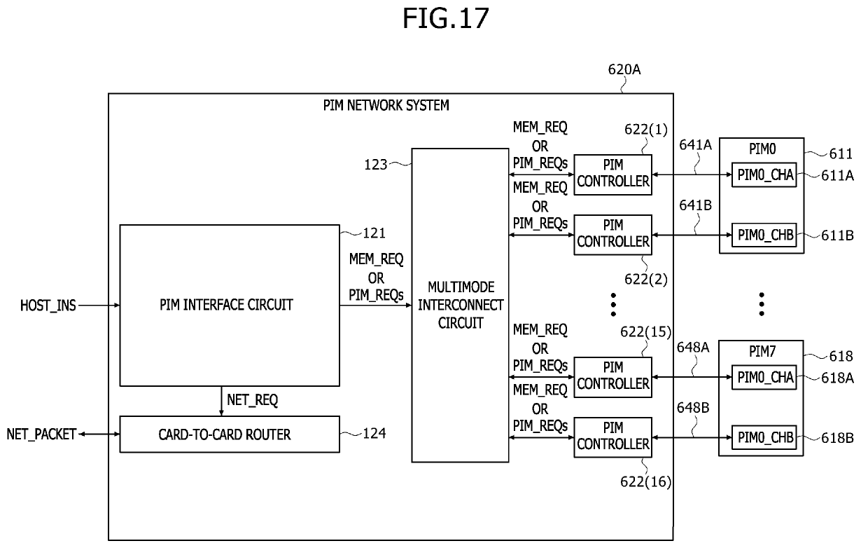

FIG. 17 is a block diagram illustrating a configuration of a PIM network system 620A that may be employed in the PIM-based accelerating device 600 of FIG. 16 according to an example, and a coupling structure between the PIM controllers 622(1)-622(16) and the first to eighth PIM devices 611-618 in the PIM network system 620A. In FIG. 17, the same reference numerals as those in FIGS. 7 and 16 denote the same components, and duplicate descriptions will be omitted below.

Referring to FIG. 17, the PIM network system 620A may include a PIM interface circuit 121, a multimode interconnect circuit 123, a plurality of PIM controllers, for example, first to sixteenth PIM controllers 622(1)-622(16), and a card-to-card router 124. The PIM interface circuit 121 may have the same configuration as described with reference to FIG. 8. As described with reference to FIGS. 9 to 11, the multimode interconnect circuit 123 may operate in any one mode of the unicast mode, the multicast mode, and the broadcast mode. Each of the first to sixteenth PIM controllers 622(1)-622(16) may have the same configuration as the first PIM controller 122(1) described with reference to FIG. 12. In the first to sixteenth PIM controllers 622(1)-622(16), each two PIM controllers corresponding to the number of channels to which each of the first to eighth PIM devices (PIM0-PIM7) 611-618 is coupled may form a pair, and be coupled to each of the first to eighth PIM devices (PIM0-PIM7) 611-618. For example, the first PIM controller 622(1) and the second PIM controller 622(2) may be coupled to the first PIM device 611. In this case, the first PIM controller 622(1) may be coupled to the first channel A-PIM device (PIM0-CHA) 611A through the first channel A signal/data line 641A. The second PIM controller 622(2) may be coupled to the first channel B-PIM device (PIM0-CHB) 611B through the first channel B signal/data line 641B. Similarly, the fifteenth PIM controller 622(15) and the sixteenth PIM controller 622(16) may be coupled to the eighth PIM device 618. In this case, the fifteenth PIM controller 622(15) may be coupled to the eighth channel A-PIM device (PIM7-CHA) 618A of the eighth PIM device 618 through the eighth channel A signal/data line 648A. The sixteenth PIM controller 622(16) may be coupled to the eighth channel B-PIM device (PIM7-CHB) 618B of the eighth PIM device 618 through the eighth channel B signal/data line 648B.

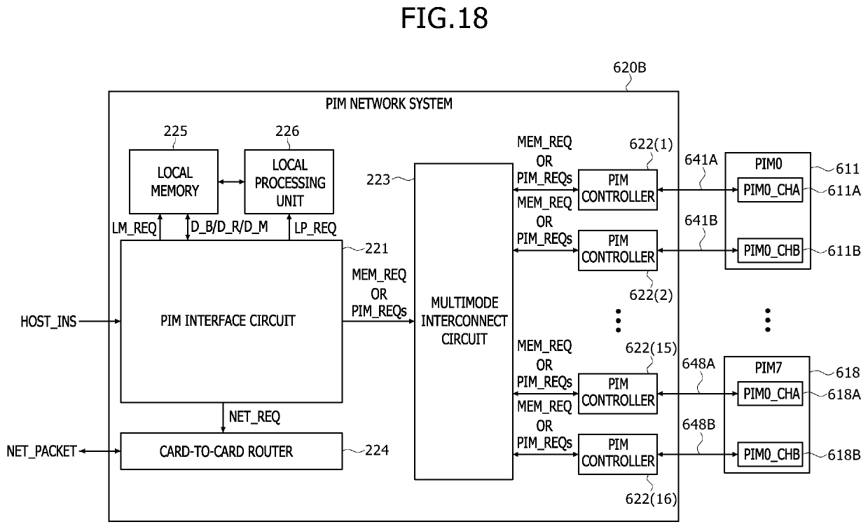

FIG. 18 is a block diagram illustrating a configuration of a PIM network system 620B that may be employed in the PIM-based accelerating device 600 of FIG. 16 according to another example, and a coupling structure between the PIM controllers 622(1)-622(16) and the first to eighth PIM devices 611-618 in the PIM network system 620B. In FIG. 18, the same reference numerals as those in FIGS. 13, 16, and 17 denote the same components, and duplicate descriptions will be omitted below.

Referring to FIG. 18, the PIM network system 620B may include a PIM interface circuit 221, a multimode interconnect circuit 223, a plurality of PIM controllers, for example, first to sixteenth PIM controllers 622(1)-622(16), a card-to-card router 224, a local memory 225, and a local processing unit 226. The PIM interface circuit 221 may have the same configuration as described with reference to FIG. 14. The multimode interconnect circuit 223 may operate in any one of the unicast mode, the multicast mode, and the broadcast mode. Each of the first to sixteenth PIM controllers 622(1)-622(16) may have the same configuration as the first PIM controller 122(1) described with reference to FIG. 12. As described with reference to FIG. 17, in the first to sixteenth PIM controllers 622(1)-622(16), each two PIM controllers corresponding to the number of channels to which each of the first to eighth PIM devices (PIM0-PIM7) 611-618 is coupled may form a pair, and be coupled to each of the first to eighth PIM devices (PIM0-PIM7) 611-618.

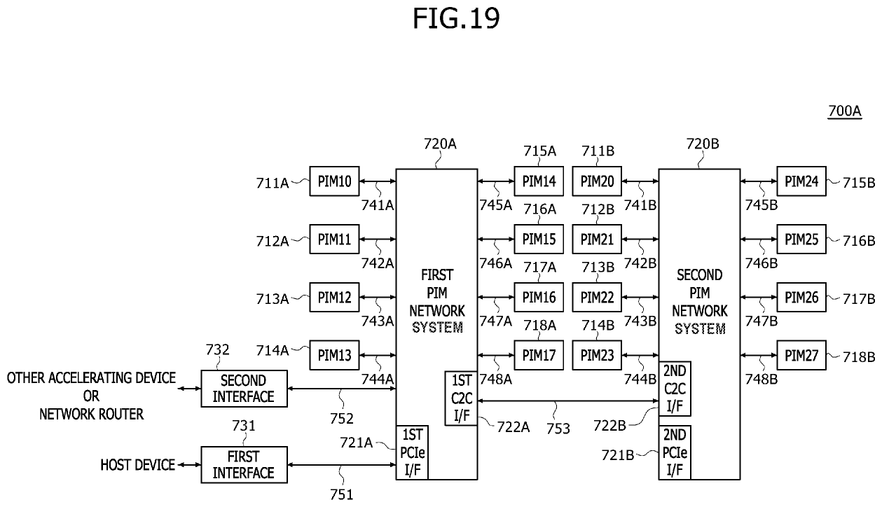

FIG. 19 is a block diagram illustrating a PIM-based accelerating device 700A according to another embodiment of the present disclosure.

Referring to FIG. 19, the PIM-based accelerating device 700A may include a plurality of PIM network systems, for example, a first PIM network system 720A and a second PIM network system 720B, a first group of PIM devices, for example, first to eighth PIM devices (PIM10-PIM17) 711A-718A, a second group of PIM devices, for example, ninth to sixteenth PIM devices (PIM20-PIM27) 711B-718B, a first interface 731, and a second interface 732. The first PIM network system 720A and the second PIM network system 720B may be configured similarly to the PIM network system (120A in FIG. 7) described with reference to FIG. 7, or the PIM network system (120B in FIG. 13) described with reference to FIG. 13, respectively. The first PIM network system 720A and the second PIM network system 720B may have the same structure as each other, but may have different structures from each other.

The first PIM network system 720A may include a first high-speed interface, for example, a first PCIe interface 721A and a first chip-to-chip interface (1st C2C I/F) 722A. The second PIM network system 720B may include a second high-speed interface, for example, a second PCIe interface 721B and a second chip-to-chip interface (2nd C2C I/F) 722B. Each of the first PCIe interface 721A and the second PCIe interface 721B may be replaced with a CXL interface or a USB interface. Each of the first PCIe interface 721A of the first PIM network system 720A and the second PCIe interface 721B of the second PIM network system 720B may correspond to the host interfaces 511 described with reference to FIGS. 8 and 14. Each of the first to sixteenth PIM devices 711A-718A and 711B-718B may be configured similarly to the first PIM device (111 in FIGS. 2 and 3) described with reference to FIGS. 2 and 3.

The first PIM network system 720A may be coupled to the first group of PIM devices, that is, the first to eighth PIM devices 711A-718A through first to eighth signal/data lines 741A-748A. For example, the first PIM network system 720A may be coupled to the first PIM device 711A through the first signal/data line 741A. The first PIM network system 720A may be coupled to the second PIM device 712A through the second signal/data line 742A. Similarly, the first PIM network system 720A may be coupled to the eighth PIM device 718A through the eighth signal/data line 748A.

The second PIM network system 720B may be coupled to the second group of PIM devices, that is, the first to eighth PIM devices 711B-718B through ninth to sixteenth signal/data lines 741B-748B. For example, the second PIM network system 720B may be coupled to the ninth PIM device 711B through the ninth signal/data line 741B. The second PIM network system 720B may be coupled to the tenth PIM device 712B through the tenth signal/data line 742B. Similarly, the second PIM network system 720B may be coupled to the sixteenth PIM device 718B through the sixteenth signal/data line 748B. Accordingly, traffic control of signals and data for the first to eighth PIM devices 711A-718A may be performed by the first PIM network system 720A. In addition, traffic control of signals and data for the ninth to sixteenth PIM devices 711B-718B may be performed by the second PIM network system 720B.

The first interface 731 may perform interfacing between the PIM-based accelerating device 700A and a host device. In an example, the first interface 731 may operate by a PCIe protocol, a CXL protocol, or a USB protocol. The first interface 731 may transmit signals and data transmitted from the host device to the first PIM network system 720A through a first interface bus 751. The first interface 731 may transmit signals and data transmitted from the first PIM network system 720A through the first interface bus 751 to the host device. In this example, the first interface 731 may be coupled to a first PCIe interface 721A of the first PIM network system 720A. On the other hand, the first interface 731 might not be coupled to a second PCIe interface 721B of the second PIM network system 720B. Therefore, the second PIM network system 720B might not directly communicate with the host device, but may communicate with the host device through the first PIM network system 720A.

The second interface 732 may perform interfacing between the PIM-based accelerating device 700A and another PIM-based accelerating device or a network router. In an example, the second interface 732 may be a device employing a communication standard, for example, the Ethernet standard. In an example, the second interface 732 may be an SFP port. The second interface 732 may transmit data that is transmitted from the first PIM network system 720A of the PIM-based accelerating device 700A through the second interface bus 752 to a first PIM network system of another PIM-based accelerating device. In addition, the second interface 732 may transmit data that is transmitted from another PIM-based accelerating device to the first PIM network system 720A through the second interface bus 752. Such data transmission may be performed through a network router between the PIM-based accelerating devices. Although not shown in FIG. 19, in another example, the second interface 732 may also be coupled with the second PIM network system 720B.

The first chip-to-chip interface 722A of the first PIM network system 720A may be coupled to the second chip-to-chip interface 722B of the second PIM network system 720B through a third interface bus 753. The first PIM network system 720A may transmit signals and data that are transmitted from the host device to the first PCIe interface 721A through the first interface 731 and the first interface bus 751 to the second chip-to-chip interface 722B of the second PIM network system 720B through the first chip-to-chip interface 722A and the third interface bus 753. Similarly, the second PIM network system 720B may transmit the signals and data from the second chip-to-chip interface 722B to the first chip-to-chip interface 722A of the first PIM network system 720A through the third interface bus 753. In this case, the first PIM network system 720A may transmit the signals and data received through the first chip-to-chip interface 722A to the host device through the first PCIe interface 721A, the first interface bus 751, and the first interface 731.

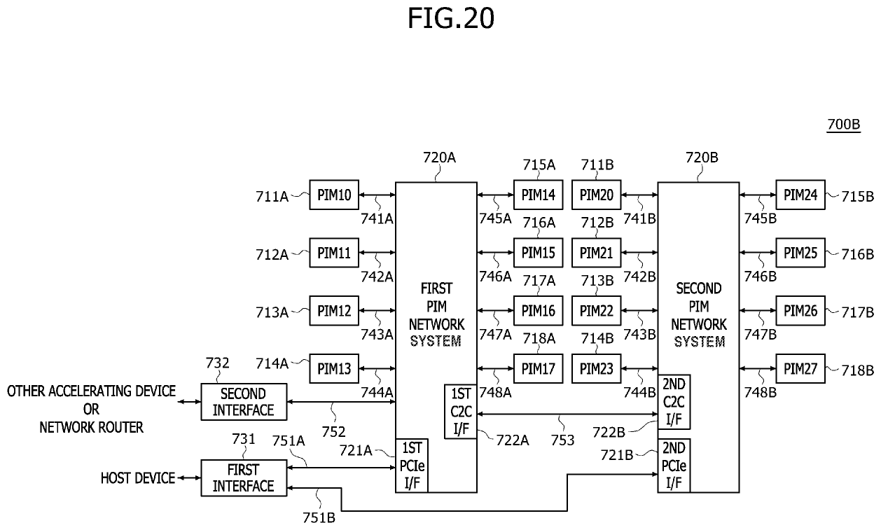

FIG. 20 is a block diagram illustrating a PIM-based accelerating device 700B according to another embodiment of the present disclosure. In FIG. 20, the same reference numerals as those in FIG. 19 denote the same components, and accordingly, overlapping descriptions will be omitted below, and differences from the PIM-based accelerating device 700A described with reference to FIG. 19 will be mainly described.

Referring to FIG. 20, in the PIM-based accelerating device 700B, a first interface 731 may be commonly coupled to a first PIM network system 720A and a second PIM network system 720B. Specifically, the first interface 731 may be coupled to a first PCIe interface 721A of the first PIM network system 720A through a first interface bus 751A. In addition, the first interface 731 may be coupled to a second PCIe interface 721B of the second PIM network system 720B through a second interface bus 751B. Accordingly, the first PIM network system 720A and the second PIM network system 720B may directly communicate with a host device through the first interface 731. In addition, the first PIM network system 720A and the second PIM network system 720B may receive and transmit signals and data from and to each other using a first chip-to-chip interface 722A and a second chip-to-chip interface 722B

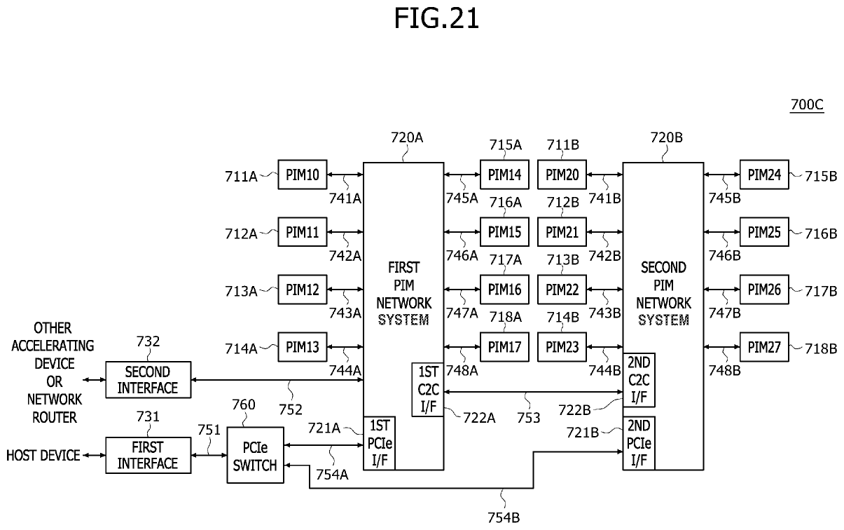

FIG. 21 is a block diagram illustrating a PIM-based accelerating device 700C according to another embodiment of the present disclosure. In FIG. 21, the same reference numerals as those in FIGS. 19 and 20 denote the same components. Accordingly, overlapping descriptions are omitted below, and differences from the PIM-based accelerating devices 700A and 700B described with reference to FIGS. 19 and 20 will be mainly described.

Referring to FIG. 21, the PIM-based accelerating device 700C may include a high-speed interface switch, for example, a PCIe switch 760. In an example, the PCIe switch 760 may be replaced with a CXL switch or a USB switch. The PCIe switch 760 may be coupled to a first interface 731 through a first interface bus 751. The PCIe switch 760 may be coupled to a first PCIe interface 721A of a first network system 720A through a fourth interface bus 754A. The PCIe switch 760 may be coupled to a second PCIe interface 721B of a second PIM network system 720B through a fifth interface bus 754B. In an example, a signal transmission bandwidth of the first interface bus 751 may be the same as a signal transmission bandwidth of the fourth interface bus 754A and a signal transmission bandwidth of the fifth interface bus 754B.

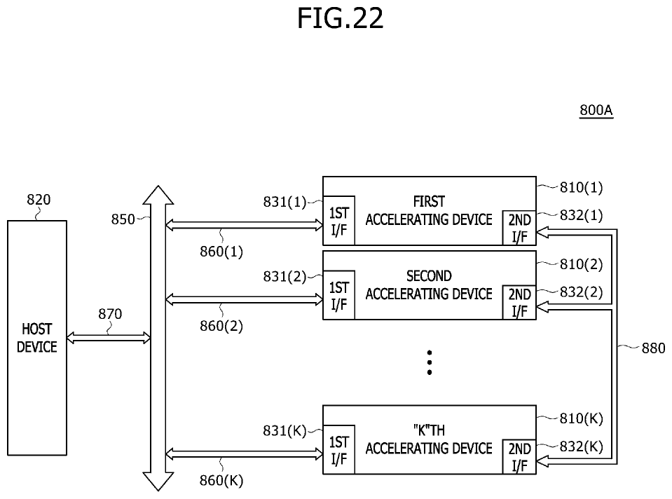

FIG. 22 is a block diagram illustrating a PIM-based accelerating system 800A according to an embodiment of the present disclosure.

Referring to FIG. 22, the PIM-based accelerating system 800A may include a plurality of PIM-based accelerating devices, for example, first to “K”^{th} PIM-based accelerating devices 810(1)-810(K) and a host device 820. Each of the first to “K”^{th} PIM-based accelerating devices 810(1)-810(K) may be one of the PIM-based accelerating device 100 described with reference to FIG. 1, the PIM-based accelerating device 600 described with reference to FIG. 14, and the PIM-based accelerating devices 700A, 700B, and 700C described with reference to FIGS. 16 to 18. The first to “K”^{th} PIM-based accelerating devices 810(1)-810(K) may include first interfaces 831(1)-831(K), respectively, and second interfaces 832(1)-832(K), respectively. For example, the first PIM-based accelerating device 810(1) may include the first interface 831(1) and the second interface 832(1). The second PIM-based accelerating device 810(2) may include the first interface 831(2) and the second interface 832(2). Similarly, the “K”^{th} PIM-based accelerating device 810(K) may include the first interface 831(K) and the second interface 832(K).

Each of the first interfaces 831(1)-831(K) may be the first interface 131 described with reference to FIGS. 1 and 14 or the first interface 731 described with reference to FIGS. 16 to 18. Each of the second interfaces 832(1)-832(K) may be the second interface 132 described with reference to FIGS. 1 and 14 or the second interface 732 described with reference to FIGS. 16 to 18. Accordingly, the first to “K”^{th} PIM-based accelerating devices 810(1)-810(K) may communicate with a host device 820 using the first interfaces 831(1)-831(K). In addition, the first to “K”^{th} PIM-based accelerating devices 810(1)-810(K) may communicate with other PIM-based accelerating devices using the second interfaces 832(1)-832(K).

A system bus 850 may be disposed between the first to “K”^{th} PIM-based accelerating devices 810(1)-810(K) and the host device 820. The first to “K”^{th} PIM-based accelerating devices 810(1)-810(K) may communicate with the system bus 850 through first to “K”^{th} interface buses 860(1)-860(K), respectively. The host device 820 may communicate with the system bus 850 through a host bus 870. The first to “K”^{th} PIM-based accelerating devices 810(1)-810(K) may communicate with each other through a network line, for example, an Ethernet line 880.

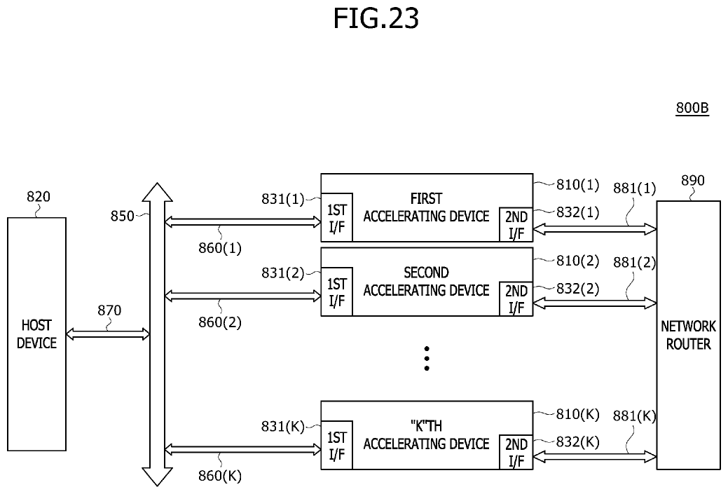

FIG. 23 is a block diagram illustrating a PIM-based accelerating system 800B according to another embodiment of the present disclosure. In FIG. 23, the same reference numerals as those in FIG. 22 denote the same components, and duplicate descriptions will be omitted below.

Referring to FIG. 23, the PIM-based accelerating system 800B may include a plurality of PIM-based accelerating devices, for example, first to “K”^{th} PIM-based accelerating devices 810(1)-810(K), a host device 820, and a network router 890. The first to “K”^{th} PIM-based accelerating devices 810(1)-810(K) may be coupled to the network router 890 through first to “K”^{th} network lines 881(1)-881(K), respectively. Specifically, the network router 890 may be coupled to second interfaces 832(1)-832(K) of the first to “K”^{th} PIM-based accelerating devices 810(1)-810(K) through the first to “K”^{th} network lines 881(1)-881(K), respectively. The network router 890 may perform routing operations on network packets transmitted from the second interfaces 832(1)-832(K) of the first to “K”^{th} PIM-based accelerating devices 810(1)-810(K) through the first to “K”^{th} network lines 881(1)-881(K), respectively. In an example, the network packet transmitted from the first PIM-based accelerating device 810(1) to the network router 890 may be transmitted to at least one PIM-based accelerating device among the second to “K”^{th} PIM-based accelerating devices 810(2)-810(K).

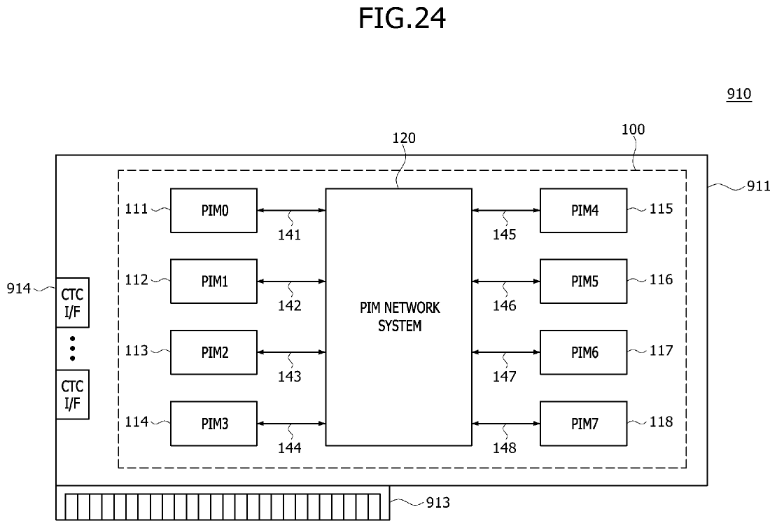

FIG. 24 is a diagram illustrating a PIM-based accelerating circuit board or “card” 910 according to an embodiment of the present disclosure. In FIG. 24, the same reference numerals as those in FIG. 1 denote the same components.

Referring to FIG. 24, the PIM-based accelerating card 910 may include a PIM-based accelerating device 100 mounted on a substrate, for example, a printed circuit board (PCB) 911, and a first interface device 913 embodied as an edge connector, and a second interface device 914, both of which are attached to the PCB 911. The PIM-based accelerating device 100 may include a plurality of PIM devices, for example, first to eighth PIM devices 111-118 and a PIM network system 120. Each of the first to eighth PIM devices 111-118 and the PIM network system 120 may be mounted on a surface of the PCB 911 in the form of a chip or a package. First to eighth signal/data lines 141-148 providing signal/data transmission paths between the first to eighth PIM devices 111-118 and the PIM network system 120 may be disposed in the form of wires in the PCB 911. For the PIM-based accelerating device 100, the contents described with reference to FIGS. 1 to 15 may be equally applied.

The first interface device 913 may be a high-speed interface terminal conforming to high-speed interfacing for high-speed communication with the host device. In an example, the first interface device 913 may be a PCIe terminal. In another example, the first interface device 913 may be a CXL terminal or a USB terminal. The first interface device 913 may be physically coupled to a high-speed interface slot or port on a board on which the host device is disposed, such as a PCIe slot, a CXL slot, or a USB port. Although omitted from FIG. 24, the first interface device 913 and the PIM network system 120 may be coupled to each other through wiring of the PCB 911.

The second interface device 914 may be configured as a card-to-card interface device for signal and data transmission with another PIM-based accelerating card or a network router. In an example, the second interface device 914 may be an SFP port or an Ethernet port. In this case, the second interface device 914 may be controlled by a network controller in the PIM network system 120. In addition, the second interface device 914 may be coupled to another PIM-based accelerating card or a network router through a network cable. The second interface device 914 may be disposed in a plural number.

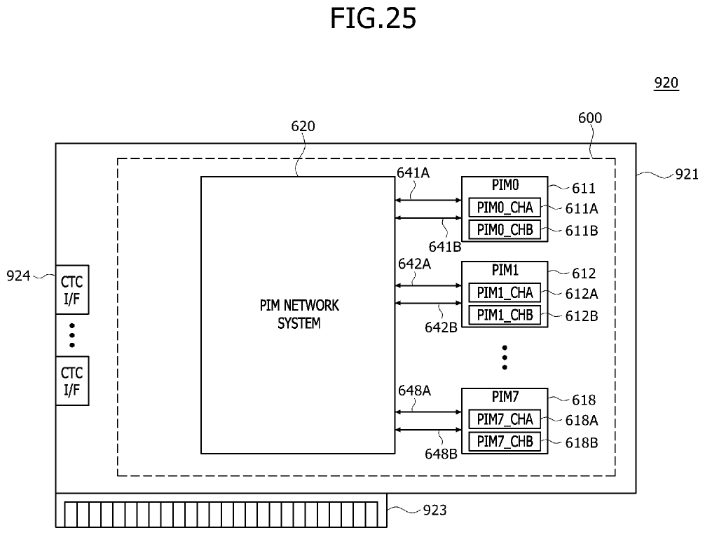

FIG. 25 is a diagram illustrating a PIM-based accelerating card 920 according to another embodiment of the present disclosure. In FIG. 25, the same reference numerals as those in FIG. 16 denote the same components.

Referring to FIG. 25, the PIM-based accelerating card 920 may include a PIM-based accelerating device 600 mounted over a substrate, for example, a printed circuit board (PCB) 921, and a first interface device 923 and a second interface device 924 that are attached to the PCB 921. The PIM-based accelerating device 600 may include a plurality of PIM devices, for example, first to eighth PIM devices 611-618 and a PIM network system 620. Each of the first to eighth PIM devices 611-618 and the PIM network system 620 may be mounted on a surface of the PCB 921 in the form of a chip or a package. Each of the first to eighth PIM devices 611-618 may include a plurality of channel-PIM devices. As illustrated in FIG. 21, the first to eighth PIM devices 611-618 may include first to eighth channel A-PIM devices 611A-618A and first to eighth channel B-PIM devices 611B-618B. First to eighth channel A signal/data lines 641A-648A and first to eighth channel B signal/data lines 641B-648B providing signal/data transmission paths between the first to eighth PIM devices 611-618 and the PIM network system 620 may be disposed in the form of wires in the PCB 911. For the PIM-based accelerating device 600, the contents described with reference to FIGS. 16 to 18 may be equally applied.

The first interface device 923 may be a high-speed interface terminal conforming to high-speed interfacing for high-speed communication with the host device. In an example, the first interface device 923 may be a PCIe terminal. In another example, the first interface device 923 may be a CXL terminal or a USB terminal. The first interface device 923 may be physically coupled to a high-speed interface slot or port on a board on which a host device is disposed, such as a PCIe slot, a CXL slot, or a USB port. Although omitted from FIG. 25, the first interface device 923 and the PIM network system 620 may be coupled to each other through wiring of the PCB 921.

The second interface device 924 may be configured as a card-to-card interface device for signal and data transmission with another PIM-based accelerating card or a network router. In an example, the second interface device 924 may be an SFP port or an Ethernet port. In this case, the second interface device 924 may be controlled by a network controller in the PIM network system 620. In addition, the second interface device 924 may be coupled to another PIM-based accelerating card or a network router through a network cable. The second interface device 924 may be disposed in a plural number.

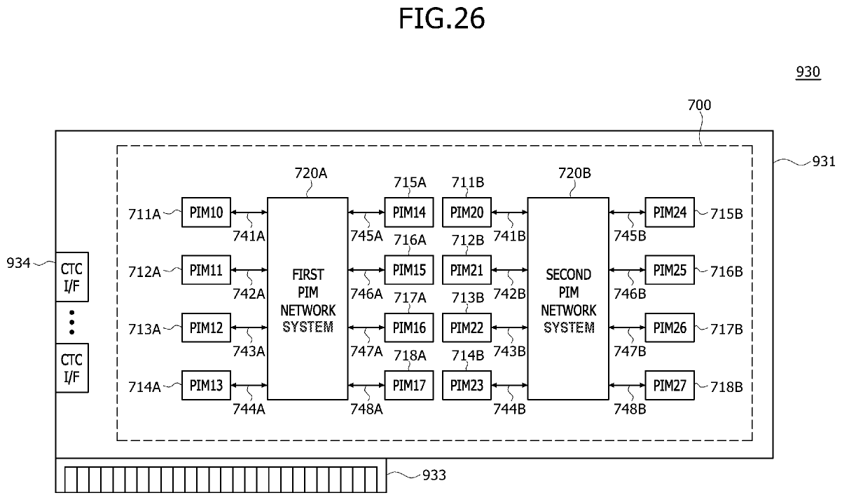

FIG. 26 is a diagram illustrating a PIM-based accelerating card 930 according to another embodiment of the present disclosure. In FIG. 26, the same reference numerals as those in FIGS. 19 and 20 denote the same components.

Referring to FIG. 26, the PIM-based accelerating card 930 may include a PIM-based accelerating device 700 mounted on a substrate, for example, a printed circuit board (PCB) 931, and a first interface device 933 and a second interface device 934 that are attached to the printed circuit board 931. The PIM-based accelerating device 700 may include a plurality of PIM devices, for example, first to sixteenth PIM devices 711A-718A and 711B-718B, and a plurality of PIM network systems, for example, first and second PIM network systems 720A and 720B. Each of the first to sixteenth PIM devices 711A-718A and 711B-718B and the first and second PIM network systems 720A and 720B may be mounted on a surface of the PCB 931 in the form of a chip or a package. The first to eighth PIM devices 711A-718A may be coupled to the first PIM network system 720A through first to eighth signal/data lines 741A-748A. The ninth to sixteenth PIM devices 711B-718B may be coupled to the second PIM network system 720B through ninth to sixteenth signal/data lines 741B-748B. The first to sixteenth signal/data lines 741A-748A and 741B-748B may be disposed in the form of wires in the PCB 931. The PIM-based accelerating device 700 may be the PIM-based accelerating device 700A described with reference to FIG. 19 or the PIM-based accelerating device 700B described with reference to FIG. 20. Accordingly, the contents described with reference to FIGS. 19 and 20 may be equally applied for the PIM-based accelerating device 700.

The first interface device 933 may be a high-speed interface terminal conforming to high-speed interfacing for high-speed communication with the host device. In an example, the first interface device 933 may be a PCIe terminal. In another example, the first interface device 933 may be a CXL terminal or a USB terminal. The first interface device 933 may be physically coupled to a high-speed interface slot or port on a board on which a host device is disposed, such as a PCIe slot, a CXL slot, or a USB port. Although omitted from FIG. 26, when the PIM-based accelerating device 700 corresponds to the PIM-based accelerating device 700A described with reference to FIG. 19, the first interface device 933 and the first PIM network system 720A may be coupled to each other through wiring of the PCB 931. When the PIM-based accelerating device 700 corresponds to the PIM-based accelerating device 700B described with reference to FIG. 20, the first interface device 933 and the first and second PIM network systems 720A and 720B may be coupled to each other through wiring of the PCB 931.

The second interface device 934 may be configured as a card-to-card interface device for signal and data transmission with another PIM-based accelerating card or a network router. In an example, the second interface device 934 may be an SFP port or an Ethernet port. In this case, the second interface device 934 may be controlled by network controllers in the first and second PIM network systems 720A and 720B. In addition, the second interface device 934 may be coupled to another PIM-based accelerating card or a network router through a network cable. The second interface device 934 may be disposed in a plural number.

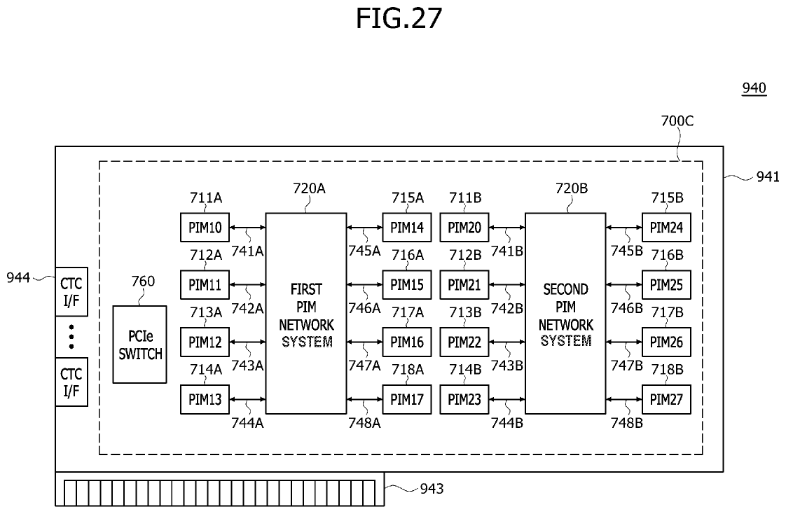

FIG. 27 is a diagram illustrating a PIM-based accelerating card 940 according to another embodiment of the present disclosure. In FIG. 27, the same reference numerals as those in FIG. 21 demote the same components.

Referring to FIG. 27, the PIM-based accelerating card 940 may include a PIM-based accelerating device 700C mounted over a substrate, for example, a printed circuit board (PCB) 941, and a first interface device 943 and a second interface device 944 that are attached to the PCB 941. The PIM-based accelerating device 700C may include a plurality of PIM devices, for example, first to sixteenth PIM devices 711A-718A and 711B-718B, a plurality of PIM network systems, for example, first and second PIM network systems 720A and 720B, and a PCIe switch 760. Each of the first to sixteenth PIM devices 711A-718A and 711B-718B and the first and second PIM network systems 720A and 720B may be mounted on a surface of the PCB 941 in the form of a chip or a package. The first to eighth PIM devices 711A-718A may be coupled to the first PIM network system 720A through first to eighth signal/data lines 741A-748A. The ninth to sixteenth PIM devices 711B-718B may be coupled to the second PIM network system 720B through ninth to sixteenth signal/data lines 741B-748B. The first to sixteenth signal/data lines 741A-748A and 741B-748B may be disposed in the form of wires in the PCB 931. The PCIe switch 760 may be configured so that a data bandwidth between the first interface 943 and the PCIe switch 760, a data bandwidth between the first PIM network system 720A and the PCIe switch 760, and a data band bandwidth between the second PIM network system 720B and the PCIe switch 760 may all be the same. For the PIM-based accelerating device 700C, the contents described with reference to FIG. 21 may be equally applied.

The first interface device 943 may be a high-speed interface terminal conforming to high-speed interfacing for high-speed communication with the host device. In an example, the first interface device 943 may be a PCIe terminal. In another example, the first interface device 943 may be a CXL terminal or a USB terminal. The first interface device 943 may be physically coupled to a high-speed interface slot or port on a board on which a host device is disposed, such as a PCIe slot, a CXL slot, or a USB port. Although omitted from FIG. 27, the first interface device 943 and the PCIe switch 760 may be coupled to each other through a wiring of the PCB 941. The PCIe switch 760 may be coupled to the first and second PIM network systems 720A and 720B through other wirings of the PCB 941.

The second interface device 944 may be configured as a card-to-card interface device for signal and data transmission with another PIM-based accelerating card or a network router. In an example, the second interface device 944 may be an SFP port or an Ethernet port. The second interface device 944 may be coupled to at least one of the first PIM network system 720A and the second PIM network system 720B of the PIM-based accelerating device 700C through the wiring of the PCB 941. The second interface device 944 may be controlled by network controllers in the first and second PIM network systems 720A and 720B. The second interface device 944 may be coupled to another PIM-based accelerating card or a network router through a network cable. The second interface device 944 may be disposed in a plural number.

The inventive concept has been disclosed in conjunction with some embodiments as described above. Those skilled in the art will appreciate that various modifications, additions and substitutions are possible, without departing from the scope and spirit of the present disclosure. Accordingly, the embodiments disclosed in the present specification should be considered from not a restrictive standpoint but an illustrative standpoint. The scope of the inventive concept is not limited to the above descriptions but defined by the accompanying claims, and all of distinctive features in the equivalent scope should be construed as being included in the inventive concept.

What is claimed is:

1. A processing-in-memory (PIM)-based accelerating device comprising:
a plurality of PIM devices;
a PIM network system configured to control traffic of signals and data for the plurality of PIM devices; and
a first interface configured to perform interfacing with a host device,
wherein the PIM network system is configured to control the traffic so that the plurality of PIM devices perform different operations, the plurality of PIM devices perform different operations for each group, or the plurality of PIM devices perform the same operation in parallel.

2. The PIM-based accelerating device of claim 1, wherein the first interface includes a peripheral component interconnect express (PCIe) interface, a compute express link (CXL) interface, or a USB interface.

3. The PIM-based accelerating device of claim 1, wherein each of the plurality of PIM devices includes:
a first memory device configured to provide first data;
a second memory device configured to provide second data; and
a processing circuit configured to perform a mathematical operation using the first data and the second data.

4. The PIM-based accelerating device of claim 3,
wherein the first memory device includes a plurality of memory banks,
wherein the second memory device includes at least one global buffer, and
wherein the processing circuit includes a plurality of processing units.

5. The PIM-based accelerating device of claim 4,
wherein one memory bank or at least two or more memory banks among the plurality of memory banks are disposed to be allocated to one processing unit among the plurality of processing units, and
wherein the global buffer is disposed to be commonly allocated to the plurality of processing units.

6. The PIM-based accelerating device of claim 4, wherein each of the plurality of processing units includes:
a multiplication circuit including a plurality of multipliers configured to perform a multiplication on the first data and the second data to generate a plurality of multiplication data;
an addition circuit configured to perform an addition on the plurality of multiplication data to generate multiplication addition data; and
an accumulative addition circuit configured to perform an accumulative addition on the multiplication addition data and latch data to generate accumulation data.

7. The PIM-based accelerating device of claim 6, wherein the accumulative addition circuit includes:
an accumulative adder configured to perform an accumulative addition on the multiplication addition data and, latch summed data to generate the accumulative data; and
a latch circuit configured to retain the accumulation data, and transmit latched data to the accumulative adder as the latch data.

8. The PIM-based accelerating device of claim 7, wherein the accumulative addition circuit further includes an output circuit configured to output or not to output the latched data output from the latch circuit as operation result data according to a logic level of an operation result data read signal.

9. The PIM-based accelerating device of claim 8, wherein the output circuit includes an activation function circuit configured to generate activation function-processed operation result data by applying an activation function to the operation result data.

10. The PIM-based accelerating device of claim 9, wherein the output circuit is configured to transmit the operation result data or the activation function-processed operation result data to the first memory circuit.

11. The PIM-based accelerating device of claim 9, wherein the output circuit is configured to transmit the operation result data or the activation function-processed operation result data to the PIM network system.

12. The PIM-based accelerating device of claim 1, wherein the PIM network system includes:
a PIM interface circuit configured to execute a host instruction to generate and output at least one of: a memory request, a plurality of PIM requests, and a network request;
a multimode interconnect circuit configured to output at least one of: the memory request and the plurality of PIM requests transmitted from the PIM interface circuit in one of a plurality modes; and
a plurality of PIM controllers each configured to generate and output at least one of: a memory command; a plurality of PIM commands corresponding to the memory request; and the plurality of PIM requests transmitted from the multimode interconnect circuit.

13. The PIM-based accelerating device of claim 12, wherein the PIM interface circuit includes:
an instruction decoder/sequencer configured to decode the host instruction and to output the host instruction or the network request in a first path or a second path, respectively, based on decoding result;
a memory/PIM request generating circuit configured to receive the host instruction from the instruction decoder/sequencer and to generate and output the memory request, the plurality of PIM requests, or a local memory request, based on the host instruction; and
a local memory circuit configured to receive the local memory request from the memory/PIM request generating circuit and to perform a local memory operation, based on the local memory request.

14. The PIM-based accelerating device of claim 13, wherein the instruction decoder/sequencer includes:
an instruction queue configured to store the host instruction; and
an instruction decoder configured to decode the host instruction stored in the instruction queue.

15. The PIM-based accelerating device of claim 13, wherein each of the plurality of PIM devices includes:
a plurality of memory banks configured to provide first data;
a global buffer configured to provide second data; and
a plurality of processing units configured to perform operation using the first data and the second data, and
wherein the local memory circuit is configured to store bias data provided to the processing units, based on the local memory request.

16. The PIM-based accelerating device of claim 13, wherein the local memory circuit is configured to store operation intermediate result value generated from the plurality of processing units, based on the local memory request.

17. The PIM-based accelerating device of claim 15, wherein the local memory circuit is configured to store operation result data or activation function-processed operation result data generated from the plurality of processing units, based on the local memory request.

18. The PIM-based accelerating device of claim 15, wherein the local memory circuit is configured to store temporary data exchanged between the plurality of processing units, based on the local memory request.

19. The PIM-based accelerating device of claim 15, wherein the local memory circuit is configured to store maintenance data for diagnosis and debugging of the plurality of PIM devices, based on the local memory request.

20. The PIM-based accelerating device of claim 13, wherein the memory/PIM request generating circuit includes a finite state machine configured to generate the memory request, the plurality of PIM requests, or the local memory request corresponding to a host instruction transmitted from the instruction sequencer, and to control scheduling for the memory request, the plurality of PIM requests, and the local memory requests.

21. The PIM-based accelerating device of claim 12, wherein the multimode interconnect circuit is configured to operate in one of first to third modes, and is configured to:
transmit the host instruction to one PIM controller among the plurality of PIM controllers in the first mode, transmit the host instruction to some PIM controllers among the plurality of PIM controllers in the second mode, and transmit the host instruction to all of the plurality of PIM controllers in the third mode.

22. The PIM-based accelerating device of claim 12, wherein the plurality of PIM controllers are configured to control the plurality of PIM devices, respectively.

23. The PIM-based accelerating device of claim 12, wherein each of the plurality of PIM controllers includes:
a request arbiter configured to output the memory request or the plurality of PIM requests transmitted from the multimode interconnect circuit through a first path and a second path, respectively;
a bank engine coupled to the request arbiter through the first path and configured to generate and output a memory command corresponding to the memory request;
a PIM engine coupled to the request arbiter through the second path and configured to generate and output a plurality of PIM commands corresponding to the plurality of PIM requests; and
a command arbiter configured to transmit the memory command and the plurality of PIM commands to the plurality of PIM devices.

24. The PIM-based accelerating device of claim 23, wherein the request arbiter includes:
a memory queue configured to store the memory request and to output the memory request in an order determined by a scheduling operation; and
a PIM queue configured to store and output the plurality of PIM requests.

25. The PIM-based accelerating device of claim 24,
wherein each of the plurality of PIM devices includes:
a plurality of memory banks configured to provide first data;
a global buffer configured to provide second data; and
a plurality of processing units configured to perform operation using the first data and the second data, and
wherein the request arbiter is configured to perform the scheduling operation for the memory request to minimize the number of row activations of the plurality of memory banks.

26. The PIM-based accelerating device of claim 24, wherein the request arbiter is configured to perform the scheduling operation so that the memory request is processed in a first ready first come first served (FR-FCFS) method.

27. The PIM-based accelerating device of claim 24, wherein the request arbiter is configured to perform the scheduling operation so that the plurality of PIM requests are output from the PIM queue in the order of input to the PIM queue.

28. The PIM-based accelerating device of claim 23, wherein each of the plurality of PIM controllers further includes a refresh engine configured to periodically generate a refresh command to transmit the refresh command to the command arbiter.

29. The PIM-based accelerating device of claim 1, further comprising a second interface for signal and data transmission with another PIM-based accelerating device or a network router.

30. The PIM-based accelerating device of claim 29, wherein the second interface includes a network port adopting the Ethernet standard or a small form-factor pluggable (SFP) port.

31. The PIM-based accelerating device of claim 29, wherein the PIM network system further includes a card-to-card router coupled to the second interface and configured to process network packets transmitted from the another PIM-based accelerating device or a network router through the second interface.

32. The PIM-based accelerating device of claim 31,
wherein the PIM interface circuit is configured to generate a network request, based on the host instruction transmitted through the first interface to transmit the network request to the card-to-card router, and
wherein the card-to-card router is configured to transmit the network packets to the second interface, based on the network request.

33. The PIM-based accelerating device of claim 1, wherein the PIM network system includes:
a PIM interface circuit configured to process a host instruction to generate and output a memory request, a plurality of PIM requests, a network request, or a local memory request;
a multimode interconnect circuit configured to output the memory request or the plurality of PIM requests transmitted from the PIM interface circuit in one mode among a plurality of modes;
a plurality of PIM controllers configured to generate and output a memory command and a plurality of PIM commands corresponding to the memory request and the plurality of PIM requests transmitted from the multimode interconnect circuit, respectively;
a card-to-card router configured to output network packets, based on the network request transmitted from the PIM interconnect circuit; and
a local memory configured to perform read and write operations requested by the local memory request transmitted from the PIM interface circuit.

34. The PIM-based accelerating device of claim 33, further comprising a second interface for signal and data transmission with another PIM-based accelerating device or a network router,
wherein the card-to-card router is configured to transmit the network packets to the second interface.

35. The PIM-based accelerating device of claim 34, wherein the second interface includes a network port adopting the Ethernet standard or a small form-factor pluggable (SFP) port.

36. The PIM-based accelerating device of claim 34, wherein each of the plurality of PIM devices includes:
a plurality of memory banks configured to provide first data;
a global buffer configured to provide second data; and
a plurality of processing units configured to perform operation using the first data and the second data, and
wherein the local memory is configured to store bias data provided to the processing units, based on the local memory request.

37. The PIM-based accelerating device of claim 36, wherein the local memory is configured to store operation intermediate results generated from the plurality of processing units, based on the local memory request.

38. The PIM-based accelerating device of claim 36, wherein the local memory is configured to store operation result data generated from the plurality of processing units or activation function-processed operation result data, based on the local memory request.

39. The PIM-based accelerating device of claim 36, wherein the local memory is configured to store temporary data exchanged between the plurality of processing units, based on the local memory request.

40. The PIM-based accelerating device of claim 36, wherein the local memory is configured to store maintenance data for diagnosis and debugging of the plurality of PIM devices, based on the local memory request.

41. The PIM-based accelerating device of claim 33,
wherein the PIM interface circuit is configured to generate and output a local processing request, based on the host instruction, and
wherein the PIM network system further includes a local processing unit configured to perform a local processing operation requested by the local processing request.

42. The PIM-based accelerating device of claim 41, wherein the local processing unit is configured to:
receive data required for the local processing operation from the PIM interface circuit or the local memory, and
transmit result data generated by the local processing operation to the local memory.

43. The PIM-based accelerating device of claim 33, wherein the PIM interface circuit includes an instruction sequencer configured to generate and output the memory request, the plurality of PIM requests, the network request, or the local memory request, based on the host instruction.

44. The PIM-based accelerating device of claim 43, wherein the instruction sequencer includes:
an instruction queue configured to store the host instruction;
an instruction decoder configured to receive the host instruction from the instruction queue and to decode the received host instruction; and
an instruction sequencing finite state machine configured to generate and output the memory request, the plurality of PIM requests, or the local memory request, based on a decoding result of the host instruction by the instruction decoder.

45. The PIM-based accelerating device of claim 44, wherein the instruction sequencer is configured to:
transmit the memory request and the plurality of PIM requests to the multimode interconnect circuit,
transmit the network request to the card-to-card router, and
transmit the local memory request to the local memory.

46. The PIM-based accelerating device of claim 44,
wherein the instruction sequencing finite state machine is configured to generate and output a local processing request, based on the host instruction, and
wherein the PIM network system further includes a local processing unit configured to perform a local processing operation requested by the local processing request.
